(19) United States
(12) Patent Application Publication
(10) Pub. No.: US 2025/0348248 A1
(43) Pub. Date: Nov. 13, 2025

(54) INSPECTION SYSTEM, INSPECTION APPARATUS AND METHOD OF CONTROLLING THE SAME

(71) Applicant: CANON KABUSHIKI KAISHA, Tokyo (JP)

(72) Inventor: ERIKA AZUMA, Tokyo (JP)

(21) Appl. No.: 19/193,228

(22) Filed: Apr. 29, 2025

(30) Foreign Application Priority Data
May 8, 2024 (JP) 2024-076089

(51) Int. Cl. G06F 3/12; H04N 1/00

(52) U.S. Cl. CPC G06F 3/1204; G06F 3/1231; H04N 1/00472; H04N 1/00822; H04N 1/00824

(57) ABSTRACT

The printing apparatus prints on a print medium based on print image data to generate a printed material and transmits/receives the print image data and print settings information of the print image data. The inspection apparatus receives the print image data and the print settings information, generates a reference image using the print image data and the print settings information, registers the generated reference image, stores settings information for inspecting the printed material, and performs an inspection of the printed material on a basis of the settings information, a scanned image of an image printed on the printed material and a reference image corresponding to the scanned image. In the inspection, if the settings information includes a predetermined setting, the inspection apparatus inspects a scanned image corresponding to a blank using a predetermined reference image.

### BACKGROUND OF THE INVENTION

### Field of the Invention

The present disclosure relates to an inspection system, an inspection apparatus and a method of controlling the same.

### Description of the Related Art

A known inspection apparatus reads a printed material printed by a printing apparatus and inspects the quality of the printed material. In the inspection, the method of determining whether or not the image of the printed material has a defect includes setting an image without defects referred to as a reference image as a comparison target and comparing the reference image and a scanned image obtained by the printed material being read.

The reference image may have a format that uses a raster image processing (RIP) image obtained by executing RIP on pre-printing image data. The RIP image is print image data that the printed material is based on, and a RIP image generated by RIP software may be used, for example. A defect such as a print mark on the printed material exists only on the printed material and not on the RIP image. Thus, when a scanned image obtained by scanning the printed material and a RIP image are compared, a defect on the printed material can be detected. In an inspection using a RIP image, a defect on a printed material is automatically detected by an apparatus instead of the user visually observing and comparing the reference image and the printed image. This has the advantageous of giving high inspection accuracy and productivity.

In a case where the reference image is a RIP image, the reference image is not generated for a page not included in the print data. For example, in the case of single-sided printing, in a registered job of the reference image for inspecting the printed material printed via single-sided printing, only a reference image of the surface (print surface) where there is print data is generated. Thus, a reference image corresponding to a blank page (blank surface) not printed on is not generated, and a blank page of a surface not printed on is not inspected using the reference image. Japanese Patent Laid-Open No. 2023-170382 describes an inspection system that performs inspection using a reference image corresponding to a blank even on a blank page without a registered reference image.

However, in the method described in Japanese Patent Laid-Open No. 2023-170382, the inspection is performed on the basis of a setting of whether or not to set all of the blank pages as inspection targets. Typically, in the case of printing a blank page on the rear side of a print surface not printed on in double-sided printing or an odd number of pages in double-sided printing, since the last blank page with no print data is included in the product, it can be thought that inspection is highly necessary. However, in the case of an insert sheet inserted between copies to make obvious the partition between copies when printing a plurality of copies, both sides of the insert sheet are blank. Yet, because the insert sheet is not a part of the product, there is no need for it to be inspected. It is conceivable that the need for inspection of a blank page on the rear side of a print surface in single-sided printing varies depending on the type of product. For example, in the case of a sheet of stamps, a glue surface not printed on is visually observed when the stamp is applied. Thus, the blank side not printed on needs to be inspected. However, in the case of a poster, the blank side not printed on faces the wall or the like and is typically not seen. Thus, it is conceivable that the blank side not printed on does not need to be inspected.

### SUMMARY OF THE INVENTION

Embodiments of the present disclosure eliminate the above-mentioned issues with conventional technology.

A feature of embodiments of the present disclosure is to provide a technique that can switch between whether or not to inspect a blank page with no generated reference image.

According to embodiments of the present disclosure, there is provided an inspection system comprising an inspection apparatus and a printing apparatus communicatively connected to one another, the printing apparatus including one or more first controllers including one or more first processors and one or more first memories, the one or more first controllers configured to: print on a print medium on a basis of print image data and generate a printed material, and transmit and receive the print image data and print settings information of the print image data, and the inspection apparatus including one or more second controllers including one or more second processors and one or more second memories, the one of more second controllers configured to: receive the print image data and the print settings information from the printing apparatus, generate a reference image using the print image data and the print settings information received, register the reference image generated, store settings information for inspecting the printed material, and perform an inspection of the printed material on a basis of the settings information, a scanned image obtained by scanning an image printed on the printed material, and a reference image corresponding to the scanned image, wherein in the inspection, if the settings information includes a predetermined setting, the one or more second controllers inspect a scanned image corresponding to a blank using a predetermined reference image.

According to embodiments of the present disclosure, there is provided an inspection apparatus configured to receive and inspect a printed material printed by a printing apparatus, comprising: one or more controllers including one or more processors and one or more memories, the one or more controllers being configured to: generate a reference image using print image data of the printed material and print settings information, register the reference image generated, store settings information for inspecting the printed material, and perform an inspection of the printed material on a basis of the settings information, a scanned image obtained by scanning an image printed on the printed material, and a reference image corresponding to the scanned image, wherein, in the inspection, if the settings information includes a predetermined setting, the one or more controllers inspect a scanned image corresponding to a blank using a predetermined reference image.

According to embodiments of the present disclosure, there is provided a method of controlling an inspection apparatus configured to receive and inspect a printed material printed by a printing apparatus, comprising: generating a reference image using the print image data of the printed material and the print settings information; registering the reference image generated; storing settings information for inspecting the printed material; and performing an inspection of the printed material on a basis of the settings information, a scanned image obtained by scanning an image printed on the printed material, and a reference image corresponding to the scanned image, wherein in the inspection, if the settings information includes a predetermined setting, inspecting a scanned image corresponding to a blank not registered in the registering using a predetermined reference image.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram illustrating the configuration of an inspection system including an inspection apparatus according to a first embodiment of the present invention.

FIG. 2 is a block diagram for describing the hardware configuration of an image forming apparatus, an inspection unit, a large-capacity stacker, a client PC, an information processing apparatus, and an inspection apparatus according to the first embodiment.

FIG. 3 is a diagram illustrating an example of a job property screen displayed on a UI unit of the client PC according to the first embodiment.

FIG. 4 is a flowchart for describing the processing by the information processing apparatus to transmit a job according to the first embodiment.

FIG. 5 is a flowchart for describing the flow of registration processing before the start of inspection in the inspection apparatus according to the first embodiment.

FIGS. 6A and 6B are flowcharts for describing processing of inspection in the inspection system according to the first embodiment and a second embodiment.

FIGS. 7A and 7B are diagrams illustrating examples of image allocation information according to the embodiments.

FIG. 8 is a diagram illustrating an example of a table storing the blank type and the inspection ON/OFF setting according to the first embodiment.

FIG. 9 is a diagram illustrating an example of a selection screen for the blank type to be inspected displayed on the UI unit of the inspection apparatus according to the second embodiment.

FIG. 10 is a diagram illustrating an example of a settings screen of an inspection operation mode displayed by the inspection apparatus according to a third embodiment.

FIGS. 11A-11C are flowcharts for describing processing of inspection in the inspection system according to the third embodiment.

FIGS. 12A-12C are flowcharts for describing the flow of inspection in the inspection system according to a fourth embodiment.

FIG. 13 is a diagram illustrating an example of a consecutive fails dialog displayed on the UI unit of the inspection apparatus according to the fourth embodiment.

FIG. 14 is a functional block diagram for describing the functional configuration of the image forming apparatus, the inspection unit, the large-capacity stacker, the client PC, the information processing apparatus, and the inspection apparatus according to the first embodiment.

FIG. 15 is a flowchart for describing job ticket generation processing in the information processing apparatus according to a modified example of the embodiments.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted. Note that unless otherwise stated, as long as the function according to the present invention is achieved, the present invention can naturally be applied a single device or an inspection apparatus including a plurality of devices. Also, unless otherwise stated, as long as the function of the present invention can be achieved, the present invention can naturally be applied to an inspection system that executes processing while connected to a network, such as a Local Area Network (LAN), a Wide Area Network (WAN), or the like. In other words, the system configuration with various types of terminals connected described in the following examples is an example, and naturally various configuration examples may be used depending on the application and purpose.

### First Embodiment

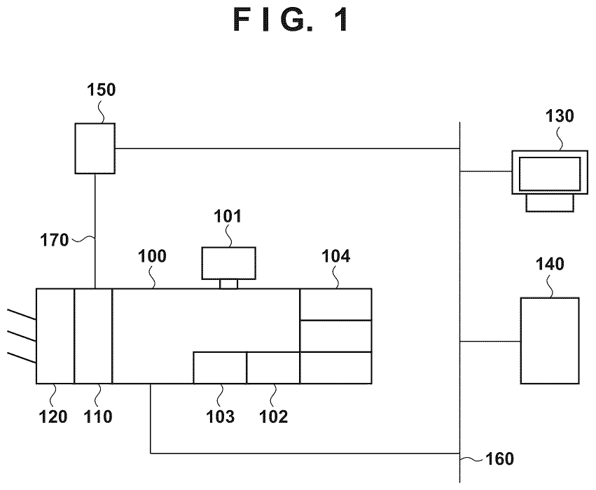

FIG. 1 is a diagram illustrating the configuration of an inspection system including an inspection apparatus according to the first embodiment of the present invention.

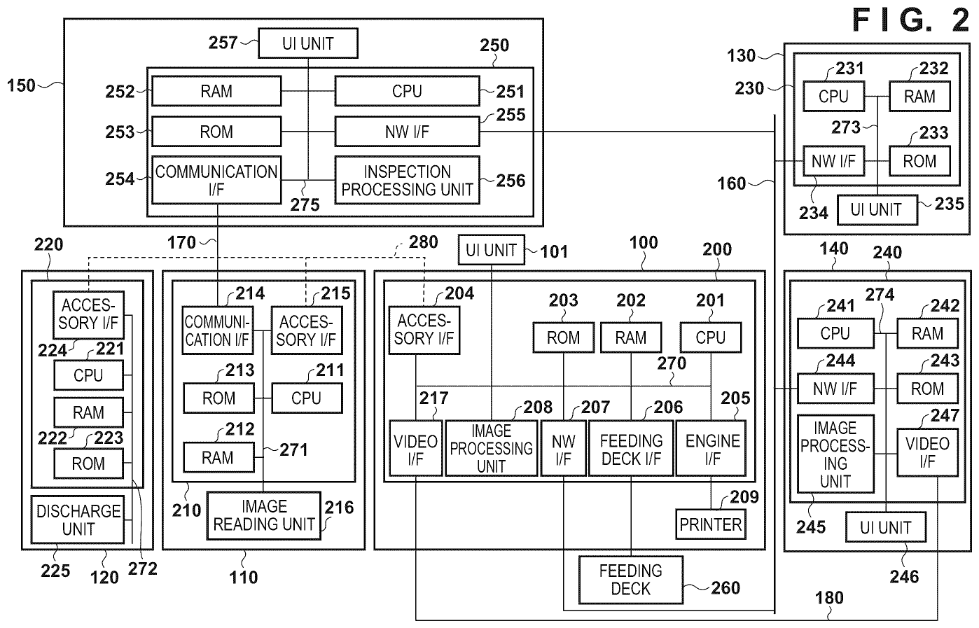

The inspection system includes an image forming apparatus 100, a client PC 130, an information processing apparatus 140, and an inspection apparatus 150 connected via a network 160. Also, an inspection unit 110 and a large-capacity stacker 120 are connected to the image forming apparatus 100. Furthermore, the inspection unit 110 and the inspection apparatus 150 are connected via a communication cable 170. The image forming apparatus 100 includes a user interface (UI) unit 101, a feeding deck 102, and a feeding deck 103 and further includes an optional deck 104 made of three levels of feeding decks. Each deck can be set with a print medium (sheet or the like) such as a print sheet. The image forming apparatus 100 performs printing output based on various types of input data such as print data transmitted from the client PC 130 or the information processing apparatus 140. Then, the image forming apparatus 100 is connected to the inspection unit 110 and the large-capacity stacker 120 via a communication cable 280 (FIG. 2), which is an internal bus.

The inspection unit 110 receives a printed material output from the image forming apparatus 100 and obtains image data for inspecting whether or not the received printed material has an image defect. Here, an image defect refers to a degradation in the quality of the printed material. This includes, for example, an image defect with a round shape (spot) caused by the color material adhering to an intended portion when printing, missing color caused by sufficient color material not being adhered to an intended portion, a linear image defect (streak), and the like. The inspection unit 110 transfers the obtained image data to the inspection apparatus 150 described below via the communication cable 170, the inspection apparatus 150 performs an inspection of whether or not there is an image defect on the printed material, and the inspection unit 110 obtains the inspection result from the inspection apparatus 150.

The large-capacity stacker 120 includes a main tray and a top tray, with thousands of sheets of paper being able to be loaded at once in the main tray. The large-capacity stacker 120 receives the printed material inspected by the inspection unit 110 and can change the discharge destination of the printed material on the basis of the inspection result from the inspection unit 110.

The image forming apparatus 100 is communicatively connected to the client PC 130, the information processing apparatus 140, and the inspection apparatus 150 via the network 160. In this embodiment, inspection is performed by the inspection apparatus 150 connected via the cable 170, but no such limitation is intended. Another configuration such as an inline inspection device may be used in which image formation, inspection, post-processing, and discharge are all performed.

A print job is generated by the client PC 130, transmitted to the information processing apparatus 140 via the network 160, and managed at the information processing apparatus 140. Then, the print job is transmitted from the information processing apparatus 140 to the image forming apparatus 100 via the network 160, and the image forming apparatus 100 executes processing to print on a sheet. Note that in another embodiment, the print job may be generated and managed at the information processing apparatus 140, transmitted to the image forming apparatus 100 via the network 160, and managed by the image forming apparatus 100.

In yet another embodiment, the client PC 130, the information processing apparatus 140, and the inspection apparatus 150 can communicate with the image forming apparatus 100 via a wireless or similar network or via a connection via a communication cable. In other words, the connection mode of the image forming apparatus 100, the information processing apparatus 140, the client PC 130, and the inspection apparatus 150 described in the embodiment is an example, and naturally various connection modes other than that described in this embodiment may be used. Also, the image forming apparatus 100 may be connected to, in addition to the inspection unit 110 and the stacker 120, a finisher that can staple, a folding machine, a binding machine, or the like.

FIG. 2 is a block diagram for describing the hardware configuration of the image forming apparatus 100, the inspection unit 110, the large-capacity stacker 120, the client PC 130, the information processing apparatus 140, and the inspection apparatus 150 according to the first embodiment.

First, the configuration of the client PC 130 will be described.

The client PC 130 is a PC for generating a print job and transmitting the print job to the information processing apparatus 140 via the network 160. The client PC 130 includes a control unit 230 and a UI unit 235. The control unit 230 includes a CPU 231, a RAM 232, a ROM 233, and a network interface (NW I/F) 234.

The central processing unit (CPU) 231 manages the control, computations, and the like of each unit inside the client PC 130 via an internal bus 273 by executing a program stored in the ROM 233 and deployed on the RAM 232. The random-access memory (RAM) 232 is a type of typical volatile storage device with direct access from the CPU 231 and is used as a working area of the CPU 231 or another temporary data storage area. The ROM 233 is a readable and writable non-volatile memory that functions as a temporary storage area and a working memory when the client PC 130 is running. The NW I/F 234 exchanges data with the information processing apparatus 140 via the network 160. The UI unit 235 includes a keyboard, a pointing device, a display, or a similar input-output device and is a device that the user can operate to input various types of setting values or designated values.

Next, the configuration of the information processing apparatus 140 will be described.

The information processing apparatus 140 executes RIP processing of image data or document data and generates a bitmap image for printing by the image forming apparatus 100. The information processing apparatus 140 also manages control relating to printing by the image forming apparatus 100 and print jobs. The information processing apparatus 140 includes a control unit 240 and a UI unit 246. The control unit 240 includes a CPU 241, a RAM 242, a ROM 243, a NW I/F 244, an image processing unit 245, and a video I/F 247.

The CPU 241 manages the control, computations, and the like of each unit inside the information processing apparatus 140 via an internal bus 274 by executing a program stored in the ROM 243 and deployed on the RAM 242. The RAM 242 is a common type of volatile storage device that can be directly accessed from the CPU 241 and is used as a working area of the CPU 241 or as a temporary data storage area. The ROM 243 is a readable and writable non-volatile memory that functions as a temporary storage area and a working memory when the information processing apparatus is running. The NW I/F 244 communicates with the client PC 130, the image forming apparatus 100, and the inspection apparatus 150 via the network 160.

Note that in another embodiment, the inspection apparatus 150 may include a NW I/F 255, and the information processing apparatus 140 may communicate with the inspection apparatus 150 via the NW I/F 255 and the NW I/F 244. For example, consider a case in which a RIP image is used as a reference image in printing by the image forming apparatus 100. In this case, the reference image may be transmitted from the inspection unit 110 to the inspection apparatus 150 via a communication I/F 214. Alternatively, it may be transmitted from the image forming apparatus 100 to the inspection apparatus 150 via a NW I/F 207 and the NW I/F 255. The image processing unit 245 executes RIP processing of the print data. The UI unit 246 includes a keyboard, a pointing device, a display, or a similar input-output device and is a device that the user can operate to input various types of setting values or designated values.

Next, the configuration of the image forming apparatus 100.

The image forming apparatus 100 performs printing output based on various types of input data such as print data transmitted from the client PC 130 or the information processing apparatus 140. The image forming apparatus 100 is connected to a UI unit 101 and a feeding deck 260. Also, the image forming apparatus 100 includes a control unit 200 and a printer 209. The control unit 200 includes a CPU 201, a RAM 202, a ROM 203, an accessory I/F 204, an engine I/F 205, a feeding deck I/F 206, a NW I/F 207, an image processing unit 208, and a video I/F 217. The control unit 200 is also connected to the printer 209 via the engine I/F 205.

The CPU 201 manages the control, computations, and the like of each unit inside the image forming apparatus 100 via an internal bus (system bus) 270 by executing a program stored in the ROM 203 and deployed on the RAM 202. The RAM 202 is a common type of volatile storage device that can be directly accessed from the CPU 201 and is used as a working area of the CPU 201 and as a temporary data storage area. The ROM 203 stores program data executed by the CPU 201 upon start up, settings data of the control unit 200, and the like. The accessory I/F 204 is connected to an accessory I/F 215 and an accessory I/F 224 via the communication cable 280. In other words, the image forming apparatus 100 communicates with the inspection unit 110 and the large-capacity stacker 120 via the accessory I/Fs 204, 215, and 224.

The engine I/F 205 manages the communications with the printer 209 and the control. The feeding deck I/F 206 manages the communications with a feeding deck 260 and the control. The feeding deck 260 is a generic term for the feeding decks 102 and 103 and the optional deck 104 in FIG. 1 as a hardware configuration. The UI unit 101 is a user interface for performing the general operations of the image forming apparatus 100.

The NW I/F 207 is connected to the NW I/F 244 of the information processing apparatus 140 via the network 160 and manages the communications of the image forming apparatus 100 with the information processing apparatus 140. Note that in this example, the interfaces connected to the internal bus 270 and the network 160 are directly connected. However, the mode of connection is not limited thereto, and the information processing apparatus 140 and the image forming apparatus 100 may be connected via a network or the like, for example. The video I/F 217 is connected to the video I/F 247 of the information processing apparatus 140 via a video cable 180 and manages the communication of image data between the information processing apparatus 140 and the image forming apparatus 100.

Note that the connection interface of the information processing apparatus 140 with the image forming apparatus 100 may have a configuration in which the functions of the NW I/F 244 and the video I/F 247 are combined. Also, the connection interface of the image forming apparatus 100 with the information processing apparatus 140 may have a configuration in which the functions of the NW I/F 207 and the video I/F 217 are combined.

The image processing unit 208 executes RIP processing for converting the image data or document data received from the video cable 180 into print data. The printer 209 prints the received binary bitmap data on a printing sheet using color material.

Next, the configuration of the inspection unit 110 will be described.

The inspection unit 110 performs control to transfer image data of a printed material obtained by an image reading unit 216 to the inspection apparatus 150 described below via the communication cable 170. The inspection unit 110 also obtains the inspection result of the printed material from the inspection apparatus 150 and transfers the inspection result to the image forming apparatus 100 or the large-capacity stacker 120. The inspection unit 110 includes a control unit 210. The control unit 210 includes a CPU 211, a RAM 212, a ROM 213, the communication I/F 214, and the accessory I/F 215.

The CPU 211 performs the control, computations, and the like of each unit inside the inspection unit 110 via an internal bus 271 by executing a program stored in the ROM 213 and deployed on the RAM 212. The RAM 212 is a common type of volatile storage device that can be directly accessed from the CPU 211 and is used as a working area of the CPU 211 and as a temporary data storage area. The ROM 213 is a readable and writable non-volatile memory that functions as a temporary storage area and a working memory when the inspection unit 110 is running. The communication I/F 214 communicates with the inspection apparatus 150 via the communication cable 170 and communicates scanned image read by the image reading unit 216, inspection results, and similar data. The accessory I/F 215 is connected to the accessory I/Fs 204 and 224 via the cable 280. The image reading unit 216 is an image reading unit that reads the printed material conveyed from the image forming apparatus 100.

Next, the configuration of the large-capacity stacker 120 will be described.

The large-capacity stacker 120 includes a control unit 220 and a discharge unit 225. The control unit 220 includes a CPU 221, a RAM 222, a ROM 223, and the accessory I/F 224. The CPU 221 manages the control, computations, and the like of each unit inside the large-capacity stacker 120 via an internal bus 272 by executing a program stored in the ROM 223 and deployed on the RAM 222. The RAM 222 is a common type of volatile storage device that can be directly accessed from the CPU 221 and is used as a working area of the CPU 221 and as a temporary data storage area. The ROM 223 is a readable and writable non-volatile memory that functions as a program, a temporary storage area, and a working memory. A discharge unit 225 manages the discharge operation to the main tray and the top tray and the monitoring and control of the load status of the main tray and the top tray. The large-capacity stacker 120 may have a configuration in which the discharge destination for the printed material conveyed from the inspection unit 110 is switched on the basis of the inspection result. For example, in a case where the discharge destination is switched in response to the inspection result of whether the printed material has a defect, a printed material without a defect is discharged to a normal stacker unit, and a printed material with a defect is discharged to a top tray. Also, it may have a configuration in which the same discharge destination is used regardless of the inspection result.

Lastly, the configuration of the inspection apparatus 150 will be described.

The inspection apparatus 150 is an apparatus for inspecting the scanned image of the printed material obtained by the inspection unit 110. The inspection apparatus 150 includes a control unit 250 and a UI unit 257. The control unit 250 includes a CPU 251, a RAM 252, a ROM 253, a communication I/F 254, the NW I/F 255, and an inspection processing unit 256.

The CPU 251 manages the control, computations, and the like of each unit inside the inspection apparatus 150 via an internal bus 275 by executing a program stored in the ROM 253 and deployed on the RAM 252. The RAM 252 is a common type of volatile storage device that can be directly accessed from the CPU 251 and is used as a working area of the CPU 251 and as a temporary data storage area. The ROM 253 is a readable and writable non-volatile memory that functions as a program and a temporary storage area and a working memory when the inspection apparatus is running. The communication I/F 254 communicates with the inspection unit 110 via the communication cable 170 and communicates scanned image obtained by the image reading unit 216 reading the printed material, inspection results, and similar data. The NW I/F 255 exchanges data with the client PC 130, the image forming apparatus 100, and the information processing apparatus 140 via the network 160. The inspection processing unit 256 inspects whether or not the printed material has a defect. The UI unit 257 includes a display connected to the inspection apparatus 150, for example, and receives a user input to the inspection apparatus 150, displays the state of the inspection apparatus 150 and inspection results, and the like.

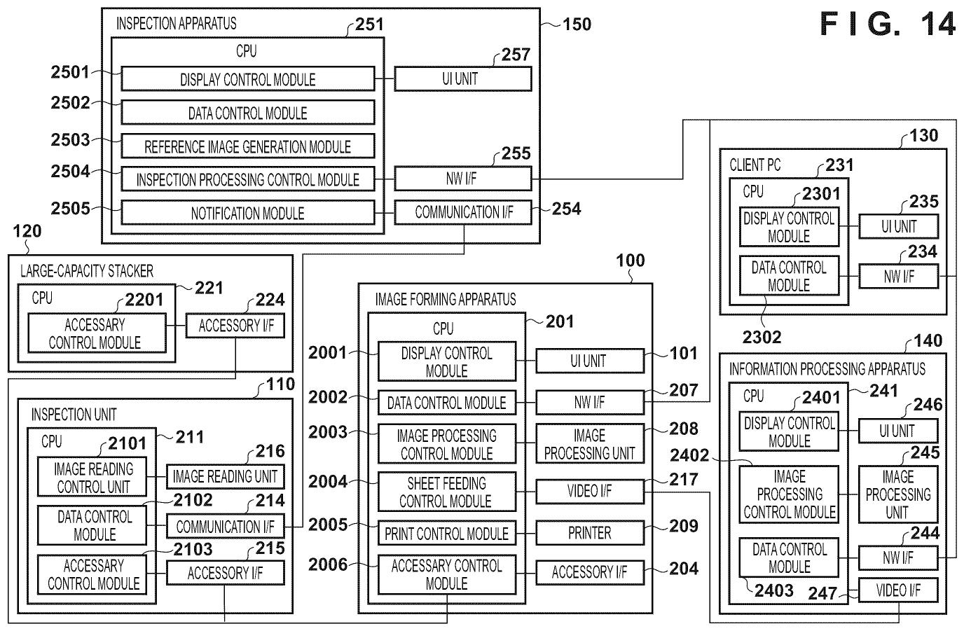

FIG. 14 is a functional block diagram for describing the functional configuration of the software of the image forming apparatus 100, the inspection unit 110, the large-capacity stacker 120, the client PC 130, the information processing apparatus 140, and the inspection apparatus 150 according to the first embodiment.

First, the function of the client PC 130 will be described.

The program of the client PC 130 is stored in the ROM 233, deployed on the RAM 232, and executed by the CPU 231. The processing function of the CPU 231 includes a display control module 2301 and a data control module 2302. The display control module 2301 displays a screen on the UI unit 235 for the user to operate. The display control module 2301 also stores print settings information in the RAM 232 when the user uses the UI unit 235 to perform print job settings and transmits an execution of printing to the data control module 2302 when print execution is performed. Print settings information refers to settings information such as printing sheet size, single-sided printing, double-sided printing, and the like. Settings information such as face up/face down discharge, normal order/reverse order printing may also be included. The data control module 2302 transmits a print job to the information processing apparatus 140 via the NW I/F 234.

Next, the function of the information processing apparatus 140 will be described.

The program of the information processing apparatus 140 is stored in the ROM 243, deployed on the RAM 242, and executed by the CPU 241. The processing function of the CPU 241 includes a display control module 2401, an image processing control module 2402, and a data control module 2403.

The display control module 2401 displays a screen on the UI unit 246 for the user to operate. The display control module 2401 also stores print settings information in the RAM 242 when the user uses the UI unit 246 to perform setting of a print job and transmits an execution of printing to the data control module 2403 when the execution of printing is performed. The image processing control module 2402 performs control of the image processing unit 245. The image processing control module 2402 executes RIP processing to convert image data or document data into bitmap image data on the basis of the print settings information stored in the RAM 242 when the execution of printing is received. Specifically, in the case of RIP processing for generating a reference image, image data is generated with the resolution converted from 600 dpi to 300 dpi, for example. In the case of RIP processing for print data, the resolution may not be lowered to generate image data of 600 dpi.

Also, in the image processing control module 2402, the RIP images are provided with respective unique image IDs in order of printing. For example, the RIP image printed first is provided with an image ID of 1, the RIP image printed second is provided with an image ID of 2, and so on.

Also, in the image processing control module 2402, when printing processing is executed in the image forming apparatus 100 not only for inspection, for example, when performing single-sided printing, since a surface not printed on a printed sheet is a blank page, the surface is provided with a blank RIP image. Also, even when performing double-sided printing, in the case of a print job that prints an odd number of pages, a surface not printed on the last printed sheets is provided with a blank RIP image in a similar manner. Also, in the settings for the client PC 130 and the information processing apparatus 140, if there is an instruction to insert blank sheets, blank RIP images (including pixel data indicating white) corresponding to the blank sheets to be inserted are provided in a predetermined page order.

In a case where, in RIP processing, the page has no data, the image processing control module 2402 determines the page to be a blank and sets a blank flag. For example, even in a case where print data or document data includes a blank page, a blank flag is set. In a case where print settings information is obtained and the front cover or back cover is defined in the print settings information, a front cover flag or a back cover flag is set.

The data control module 2403 controls the reception of print jobs from the client PC 130 and the transmission of print jobs to the image forming apparatus 100. When a print job is received from the client PC 130 via the NW I/F 244, the print job is stored in the RAM 242. Also, a print job start notification, print settings information, and a RIP image are transmitted to the image forming apparatus 100 via the NW I/F 244 and the video I/F 247. To generate a reference image, a reference image parameter is generated for each page on the basis of the print settings information. The reference image parameter includes information such as an inspection job ID, image ID, sheet size, and blank flag and is transmitted to the image forming apparatus 100. Also, the reference image parameter includes information indicating whether or not the sheet printed with an image corresponding to the reference image is the last sheet of an inspection job.

Next, the function of the image forming apparatus 100 will be describe.

The program of the image forming apparatus 100 is stored in the ROM 203, deployed on the RAM 202, and executed by the CPU 201. The processing function of the CPU 201 includes a display control module 2001, a data control module 2002, an image processing control module 2003, a feed control module 2004, a print control module 2005, and an accessory control module 2006.

The display control module 2001 displays a screen on the UI unit 101 for the user to operate. When the user operates the UI unit 101 to perform additional print job settings, in addition to the setting of the information processing apparatus 140, the additional print settings information is stored in the RAM 202. The print job settings in the image forming apparatus 100 include an insertion setting of an insert sheet such as a job-to-job partition sheet and a set-to-set partition sheet, sheet settings, and the like. Also, an execution of printing is transmitted to the data control module 2002 when printing is temporarily stopped or resumed.

The data control module 2002 controls the reception of print jobs and notifications from the information processing apparatus 140 and the transmission of these to the inspection apparatus 150. When a print job start notification is received from the information processing apparatus 140, the print settings information and RIP image received via the NW I/F 207 and the video I/F 217 are stored in the RAM 202. With a registration job for registering a RIP image as a reference image, the RIP image and reference image parameter generated and transmitted by the data control module 2403 of the information processing apparatus 140 are received, and these are then transmitted to the inspection apparatus 150 via the NW I/F 207. Also, in the present print job, image allocation information described below is transmitted. Also, an inspection job start notification is transmitted. The reference image parameter is constituted by information based on the print settings information. Also, the image allocation information includes information such as single-sided (single-sided printing/double-sided printing) based on the print settings information and additionally includes information such as the rotation and shift amount, printing surface (front or back), sheet number, and the like determined by the print control module 2005 when printing is actually performed on a sheet.

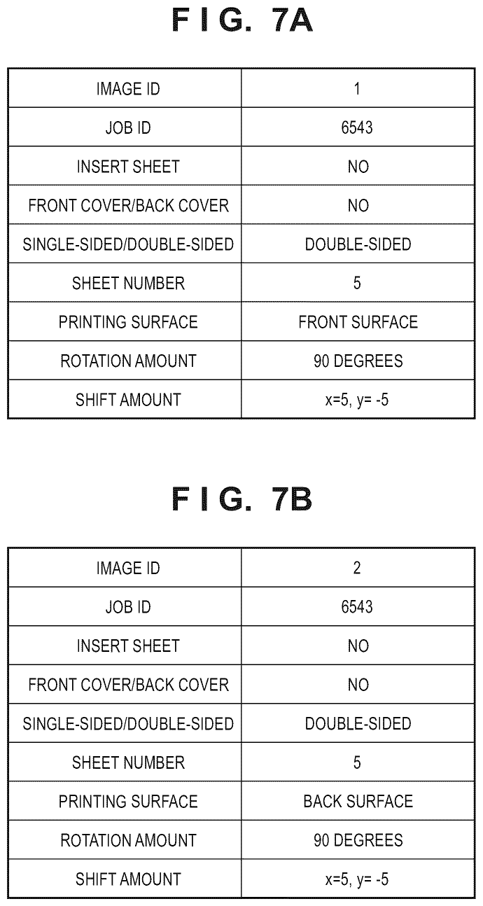

FIG. 7A illustrates an example of image allocation information. Image allocation information is generated for each page to be printed, identified by an image ID, and includes ID information of the inspection job (In FIGS. 7A and 7B, job ID “6543”). It also includes information relating to the insert sheet to be inserted during the print job in the image forming apparatus 100 (“job-to-job partition sheet” for outputting a blank sheet at the start of a print job or “set-to-set partition sheet” for outputting a blank sheet after each discretionary printed copies). For example, “Insert sheet NO” means the page indicated by the image ID is not an insert sheet.

Other information included includes whether a front cover or back cover is defined in the information processing apparatus 140. For example, “Front cover/back cover NO” means that the page indicated by the image ID is not a front cover or a back cover. Also included is information of single-sided or double-sided printing determined from the print settings information. Sheet number is included which is information indicating what number sheet for printing is the sheet that is the target of a conveyance instruction by the feed control module 2004 described below. Information of the rotation amount determined from the print settings information can also be included. For example, 90 degrees means the RIP image received from the information processing apparatus 140 is rotated 90 degrees in the clockwise direction for the conveyed sheet before imposition and printing is performed. Information of the shift amount determined from the print settings information can also be included. For example, a case where x=5 and y=−5 means that the RIP image received from the information processing apparatus 140 is moved +5 pixels in the main scan direction and −5 pixels in the sub-scan direction, where the leading end of the conveyed sheet is the origin, before imposition and printing is performed. Also, as described above, information of whether the sheet is the last sheet of the inspection job is included. Other information may be included in addition to these examples of the image allocation information, and the image allocation information is not limited to these examples. FIGS. 7A and 7B illustrate image allocation information of a front surface image and a back surface image of a sheet in double-sided printing in the same inspection job.

The image processing control module 2003 performs control of the image processing unit 208. The image processing control module 2003 obtains the printing processing information and RIP image stored in the RAM 202 and executes image processing for conversion into print data. Image processing to convert into print data includes, for example, rasterization of the PDL data, conversion to multi-value bitmap data, execution of screen processing, and the like to achieve conversion into binary bitmap data. The binary bitmap data obtained here is transmitted to the printer 209 via the engine I/F 205.

Also, the printing processing information stored in the RAM 202 is obtained, and the page set with a blank flag is provided with an image ID of 0. Making the image ID=0 is an example, and the format and content are not limited as long as it indicates a blank page. In a registration job for registering a RIP image as a reference image, the RIP image and reference image parameter for a page with an image ID of 0 are discarded and not included by the data control module 2002 in the RIP image and the reference image parameter to be transmitted to the inspection apparatus 150. In the present print job, after a page set with a blank flag is provided with an image ID of 0, all page pages are included in the image allocation information to be transmitted to the inspection apparatus 150 by the data control module 2002.

The feed control module 2004 performs control of the feeding deck 260 via the feeding deck I/F 206. The feed control module 2004 conveys a sheet to be used in printing from the feeding deck 260 to the printer 209 on the basis of the printing processing information stored in the RAM 202.

The print control module 2005 performs control of the printer 209 via the engine I/F 205. The print control module 2005 sends a printing instruction to the printer 209 to print the bitmap data transmitted from the image processing control module 2003 on the sheet conveyed by the feed control module 2004 on the basis of the printing processing information. Also, when a notification to temporarily stop or resume printing is received by the accessory control module 2006 described below, the print control module 2005 stops or resumes printing by the printer 209 on the basis of this notification.

The accessory control module 2006 notifies the large-capacity stacker 120 of the discharge destination via the accessory I/F 204 on the basis of the print settings information stored in the RAM 202. The accessory control module 2006 also notifies the print control module 2005 when a notification to temporarily stop or resume printing is received from the inspection unit 110.

Next, the function of the inspection unit 110 will be described.

The program of the inspection unit 110 is stored in the ROM 213, deployed on the RAM 212, and executed by the CPU 211. The processing function of the CPU 211 includes an image read control module 2101, a data control module 2102, and an accessory control module 2103.

The image read control module 2101 performs control of the image reading unit 216. The image reading unit 216 is provided with an imaging function installed with a contact image sensor (CIS), for example, and images a sheet that passes through the inspection unit 110 and obtains a scanned image. Note that the CIS for the image reading unit 216 is an example of a sensor that may be used, with other examples including a CCD image sensor and the like. Also, the imaging method is not limited thereto.

The data control module 2102 transmits the scanned image to the inspection apparatus 150 via the communication I/F 214. Also, the data control module 2102 receives the settings information of the inspection operation mode described below set in the inspection apparatus 150 and stores this in the RAM 212. The data control module 2102 also receives the result of the inspection operation performed by the inspection apparatus 150.

The accessory control module 2103 transmits control information to the image forming apparatus 100 and the large-capacity stacker 120 via the accessory I/F 215 on the basis of the inspection result and the settings information of the inspection operation mode received by the data control module 2102. In the case of a configuration in which the discharge destination is switched on the basis of the inspection result, the accessory control module 2103 notifies the large-capacity stacker 120 to discharge printed material without a defect to the main tray of the discharge unit 225 and to discharge printed material with a defect to the top tray of the discharge unit 225. Also, in the case of a setting where printing is temporarily stopped when there are a certain number of consecutive printed material with defects, the accessory control module 2103 transmits a notification to the image forming apparatus 100 to stop printing when the certain number (predetermined number) is reached.

Next, the function of the inspection apparatus 150 will be described.

The program of the inspection apparatus 150 is stored in the ROM 253, deployed on the RAM 252, and executed by the CPU 251. The processing function of the CPU 251 includes a display control module 2501, a data control module 2502, a reference image generation module 2503, an inspection processing control module 2504, and a notification module 2505.

The display control module 2501 displays a screen on the UI unit 257. The display control module 2501 displays the inspection result from the inspection processing control module 2504 described below stored in the RAM 252, a screen operated by the user, and the like. When the user sets the inspection operation settings via the UI unit 257, the display control module 2501 stores the inspection operation information in the RAM 252.

The data control module 2502 receives a RIP image, a reference image parameter, and image allocation information from the image forming apparatus 100 via the NW I/F 255 and stores these in the RAM 252. When an inspection job start notification is received, the data control module 2502 generates a new inspection job and stores this in the RAM 252. The data control module 2502 stores a scanned image transmitted via the communication I/F 254 in the RAM 252. Also, the data control module 2502 notifies the inspection unit 110 of the inspection result from the inspection processing control module 2504 and notifies of the inspection settings information stored in the RAM 252. When a reference image registration complete notification is received from the reference image generation module 2503 described below, the data control module 2502 notifies the image forming apparatus 100 that registration is complete.

The reference image generation module 2503 generates a reference image from the RIP image and reference image parameter stored in the RAM 252 and the image allocation information and stores this as a reference image in the RAM 252. Also, the reference image generation module 2503 determines whether the sheet is the last sheet from the reference image parameter. Control of the inspection processing unit 256 is also performed by the inspection processing control module 2504.

Next, an overview of printed image inspection in the inspection apparatus 150 will be described.

First, the scanned image stored in the RAM 252 and the corresponding reference image are read out and compared for inspection. Specifically, feature points are extracted from the reference image and the scanned image and alignment of the reference image and the scanned image is performed on the basis of the extracted feature points. If the difference between the pixel value (luminance value) of a pixel to be inspected in the scanned image after alignment and the pixel value (luminance value) of a pixel to be compared in the reference image is equal to or less than a threshold, the pixel to be inspected is determined to have passed. Note that the threshold is different for each inspection level. In the inspection, the reference image corresponding to each scanned image is referenced when performing inspection.

When the inspection of all of the pixels of the scanned image has ended, whether or not the total number of pixels determined to have failed is equal to or less than a threshold for determining pass or not is determined, and on the basis of this, whether or not the scanned image is normal is determined. If the total number of pixels determined to have failed is equal to or less than the pass threshold, the scanned image is determined to be normal. On the other hand, if the total number of pixels determined to have failed is greater than the threshold, the scanned image is determined to be not normal. The inspection result including information indicating whether or not the printed material has a defect, the type (spot or streak) of the detected defect, and the defect position information is stored in the RAM 252. Whether the sheet is the last sheet is determined from the image allocation information. The inspection apparatus 150 is also responsible for determination and processing of the inspection operation mode received by the display control module 2501.

The notification module 2505 notifies the inspection unit 110 of the inspection result via the communication I/F 254. Here, the notification module 2505 transmits the inspection operation mode, the information of the blank type to inspect, or the inspection result from the inspection processing control module 2504 stored in the RAM 252 to the inspection unit 110.

Next, the function of the large-capacity stacker 120 will be described.

The program of the large-capacity stacker 120 is stored in the ROM 223, deployed on the RAM 222, and executed by the CPU 221. The processing function of the CPU 221 includes an accessory control module 2201.

The accessory control module 2201 performs control of the discharge unit 225. The accessory control module 2201 receives a discharge notification from the image forming apparatus 100 or the inspection unit 110 and discharges to the main tray or top tray of the discharge unit 225 on the basis of the notification content. The accessory control module 2201 transmits an outside machine discharge notification to the image forming apparatus 100 or the inspection unit 110 when discharge is complete to inform them that the printed material has been discharged without a paper jam occurring inside the image forming apparatus 100, the inspection unit 110, or the large-capacity stacker 120.

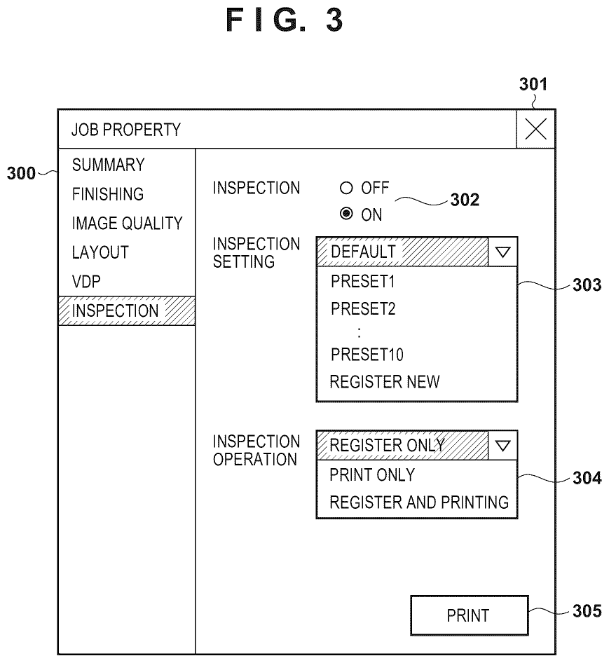

Next, selection of an inspection system for the inspection job and operations of a print job according to the first embodiment will be described with reference to FIG. 3.

FIG. 3 is a diagram illustrating an example of a job property screen displayed on the UI unit 235 of the client PC 130 according to the first embodiment.

A screen 300 is a screen for receiving print job settings from the user on the client PC 130. The display control module 2301 executed by the CPU 231 displays this screen on the UI unit 235 and receives input from the user and stores this in the RAM 232. Here, a print job generated in the client PC 130 is transmitted to the information processing apparatus 140 and managed by the information processing apparatus 140. However, in another embodiment, the information processing apparatus 140 may generate and manage a print job.

In a case where the user selects “Inspection ON” for a inspection mode setting 302, the following property is set. Here, a print job with “Inspection ON” set is referred to as an “inspection job”. In a case where “Inspection OFF” is selected, the job is treated as a normal print job without inspection being performed. In an inspection setting 303, the user selects the region to be inspected and the inspection level setting method. In a case where “Default” is selected, the inspection apparatus 150 inspects the entire surface of the image at the standard inspection level. In a case where any one of “Preset1” to “Preset10” is selected, the inspection apparatus 150 performs inspection on the basis of the pre-designated region and inspection level corresponding to the selected “Preset”. In a case where “Register New” is selected, the user can newly generate and register inspection settings, and the inspection apparatus 150 performs inspection on the basis of the registered inspection settings.

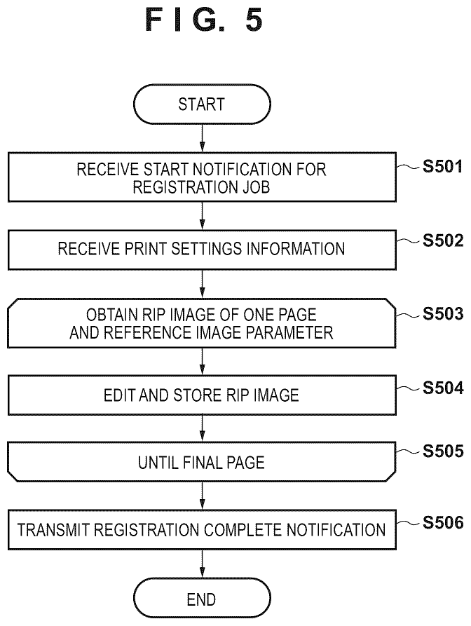

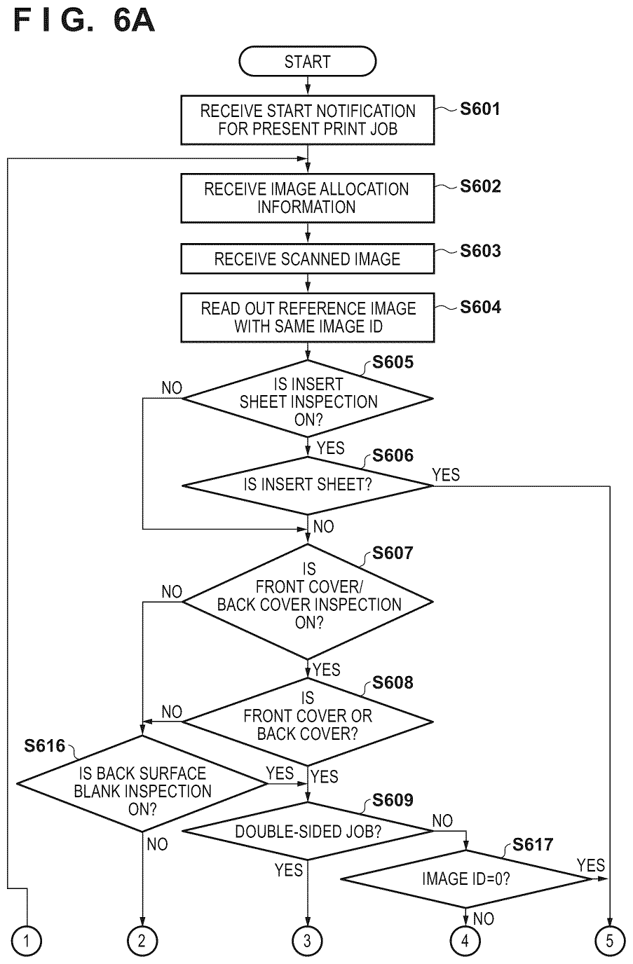

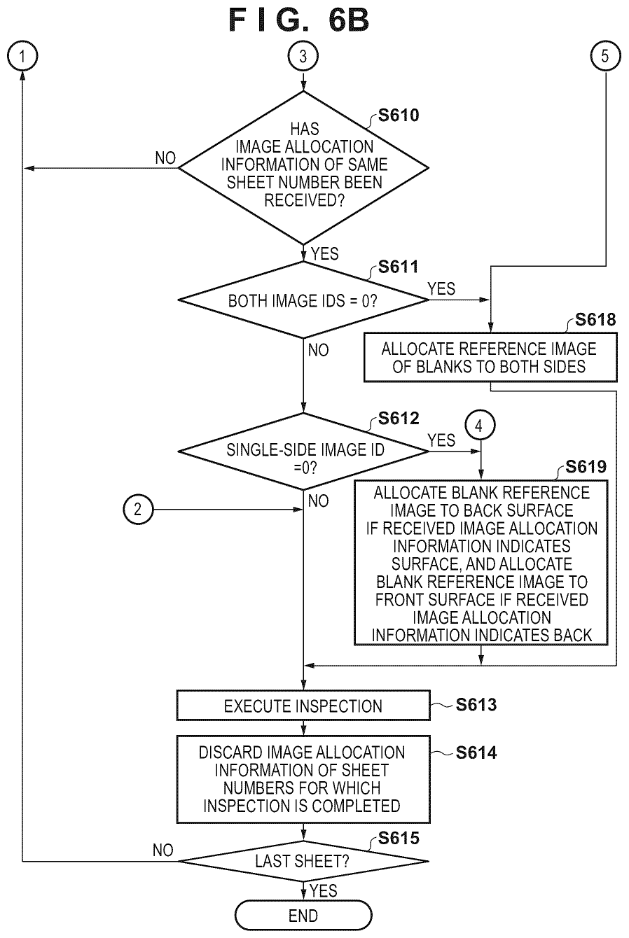

An inspection operation setting 304 allows the user to select the job to execute. Here, one of only register reference image, only printing, and register of reference image and printing may be selected. In a case where “Register only” is selected, the inspection apparatus 150 performs only registration of a reference image and the inspection setting. In a case where “Print only” is selected, printing by the image forming apparatus 100 and inspection by the inspection apparatus 150 are performed using the pre-registered reference image. In a case where “Register and printing” is selected, the operation of “Register only” and the operation of “Print only” described above are consecutively performed. The processing of generating and registering a reference image will be described below with reference to the flowchart of FIG. 5. When a print button 305 is pressed, the display control module 2301 stores the content set on this screen in the RAM 232. The data control module 2302 executed by the CPU 231 of the client PC 130 transmits the print job to the information processing apparatus 140. The data control module 2403 executed by the CPU 241 of the information processing apparatus 140 controls the execution of printing and inspection on the basis of the print settings information of the received print job. The operations of the printing and inspection according to the settings will be described below in detail with reference to FIGS. 6A and 6B. When a close button 301 is pressed, the screen is closed without storing the settings of the present screen in the RAM 232.

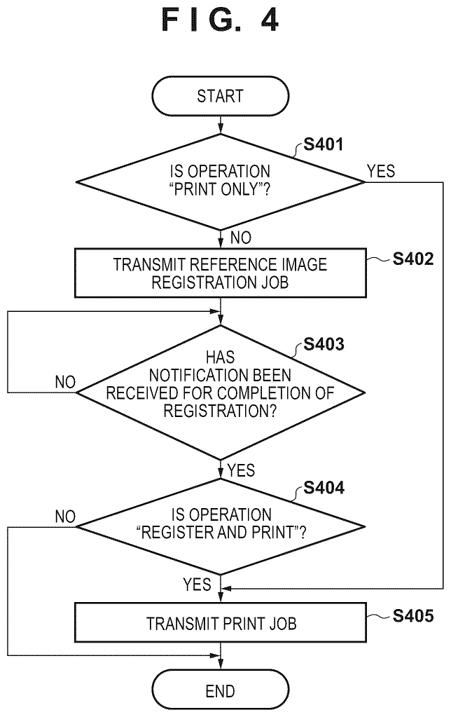

FIG. 4 is a flowchart for describing the processing by the information processing apparatus 140 to transmit the job according to the first embodiment. The processing described by the flowchart is implemented by the CPU 241 of the information processing apparatus 140 deploying program code stored in the ROM 243 on the RAM 242 and executing it.

First, in step S401, the CPU 241 functions as the data control module 2403 and determines whether or not the setting value set in the inspection operation setting 304 illustrated in FIG. 3 is “Print only”. In a case where “Print only” is set, the processing proceeds to step S405. In a case where a setting other than “Print only” is set, the processing proceeds to step S402. In step S402, the CPU 241 functions as the data control module 2403 and transmits a registration job for registering a RIP image as a reference image to the inspection apparatus 150. Here, a RIP image corresponding to the reference image, various types of print settings information, and the like are transmitted.

Next, the processing proceeds to step S403, and the CPU 241 functions as the data control module 2403 and determines whether or not a notification has been received for the completion of registration of the reference image from the inspection apparatus 150. In a case where a registration complete notification has been received, the processing proceeds to step S404. In a case where a registration complete notification has not been received, the processing is put on standby. In step S404, the CPU 241 functions as the data control module 2403 and determines whether or not the setting value set in the inspection operation setting 304 illustrated in FIG. 3 is “Register and printing”. In a case where “Register and printing” is set, the processing proceeds to step S405. In a case where “Register only” is set, the processing ends. In step S405, the CPU 241 functions as the data control module 2403 and transmits the print job for inspection to the image forming apparatus 100. Here, the RIP image to be printed on a sheet, various types of print settings information, and the like are transmitted to the image forming apparatus 100, and then the processing ends.

FIG. 5 is a flowchart for describing the flow of registration processing before the start of inspection in the inspection apparatus 150 according to the first embodiment. The processing described by the flowchart is implemented by the CPU 251 of the inspection apparatus 150 deploying a program stored in the ROM 253 on the RAM 252 and executing it. In the RIP inspection, the RIP image generated by the information processing apparatus 140 is transmitted to the inspection apparatus 150.

In step S501, the CPU 251 functions as the data control module 2502 and receives a start notification for a registration job of the reference image by the image forming apparatus 100. When a start notification for a registration job for registering the reference image is received, the data control module 2502 generates an inspection job with a unique inspection job ID and stores this in the RAM 252. Next, in step S502, the CPU 251 functions as the data control module 2502 and receives the print settings information from the image forming apparatus 100. The print settings information may be configured to be received from the information processing apparatus 140 or the client PC 130. Then, the processing proceeds to step S503, and the CPU 251 functions as the data control module 2502 and receives the RIP image and the reference image parameter from the image forming apparatus 100. In steps S503 to S505, for all of the pages, the RIP image and the reference image parameter are obtained.

In step S504, the CPU 251 functions as the reference image generation module 2503 as edits the RIP image using the reference image parameter received in step S503. Editing of the RIP image includes processing to convert into an image format suitable for the scanned image described below read at the time of inspection and convert the image size from the sheet size and number of pixels included in the reference image parameter to convert the RIP image into a reference image. Also, the CPU 251 functions as the data control module 2502 and stores the reference image obtained in the manner, the print settings information, and the reference image parameter in the RAM 252.

Next, the processing proceeds to step S505, and the CPU 251 functions as the reference image generation module 2503 and determines whether the RIP images for all of the pages have been received from the reference image parameter received in step S503 and stored in the RAM 252. In a case where reception of the images for all of the pages is complete, the processing proceeds to step S506. In a case where there are pages to follow, the processing returns to step S503, and the RIP image of the next page is received. In step S506, the CPU 251 functions as the data control module 2502 and transmits a registration complete notification to the image forming apparatus 100. Then, the CPU 201 functions as the data control module 2002 of the image forming apparatus 100 and ends the transmission of the registration job.

FIGS. 6A and 6B are flowcharts for describing the flow of inspection in the inspection system according to the first embodiment. In the processing described by the flowchart, the processing by the inspection apparatus 150 is implemented by the CPU 251 of the inspection apparatus 150 deploying a program stored in the ROM 253 on the RAM 252 and executing it. Also, the processing by the image forming apparatus 100 is implemented by the CPU 201 of the image forming apparatus 100 deploying a program stored in the ROM 203 on the RAM 202 and executing it. Furthermore, the processing of the information processing apparatus 140 is implemented by the CPU 241 of the information processing apparatus 140 deploying a program stored in the ROM 243 on the RAM 242 and executing it. Those are the same as flowcharts described below, and thus the flowcharts will not be described below.

In step S601, the CPU 251 of the inspection apparatus 150 functions as the data control module 2502 and receives a present print job start notification from the image forming apparatus 100. At this time, the CPU 201 of the image forming apparatus 100 functions as the print control module 2005 and instructs the printer 209 to print. A sheet printed on in this manner is conveyed from the image forming apparatus 100 to the inspection unit 110. In this manner, the CPU 211 of the inspection unit 110 functions as the image read control module 2101 and instructs the image reading unit 216 to scan the conveyed sheet.

Next, in step S602, the CPU 251 functions as the data control module 2502 and receives the image allocation information from the image forming apparatus 100. When the image allocation information is received, the CPU 251 functions as the reference image generation module 2503 and references the image ID of the received image allocation information and reads out the corresponding RIP image (RIP image edited using the reference image parameter in step S504) from the RAM 252. At this time, if the image ID is 0, this processing is skipped. Then, the read out RIP image and the image allocation information are used to generate a reference image, and the generated reference image and the image allocation information are stored in the RAM 252. The image allocation information includes information to be determined at the time of printing. Thus, in addition to the editing of the RIP image described in step S504, the generation of a reference image suitable to the situation for printing on the sheet is required. Thus, generation of a reference image in step S602 during the present print job is performed. At this time, the reference image generation module 2503 processes the RIP image on the basis of information such as the rotation amount, shift amount, and the like and generates the reference image. For example, in a case where the image allocation information is received as in FIG. 7A, the RIP image is rotated 90 degrees, moved +5 pixels in the main scan direction and −5 pixels in the sub-scan direction with the leading edge in the conveyance direction of the sheet as the origin, and imposition on the surface of the sheet is performed to generate the reference image.

Next, the processing proceeds to step S603, and the CPU 251 functions as the data control module 2502 and receives the scanned image obtained by the image reading unit 216 of the inspection unit 110 and stores the scanned image in the RAM 252. Next, the processing proceeds to step S604, and the CPU 251 functions as the inspection processing control module 2504 and reads out the reference image with an image ID that is the same as the image ID of the image allocation information received in step S602 from the RAM 252. Note that in a case where the image ID here is 0, this processing is skipped, and the processing proceeds to step S605.

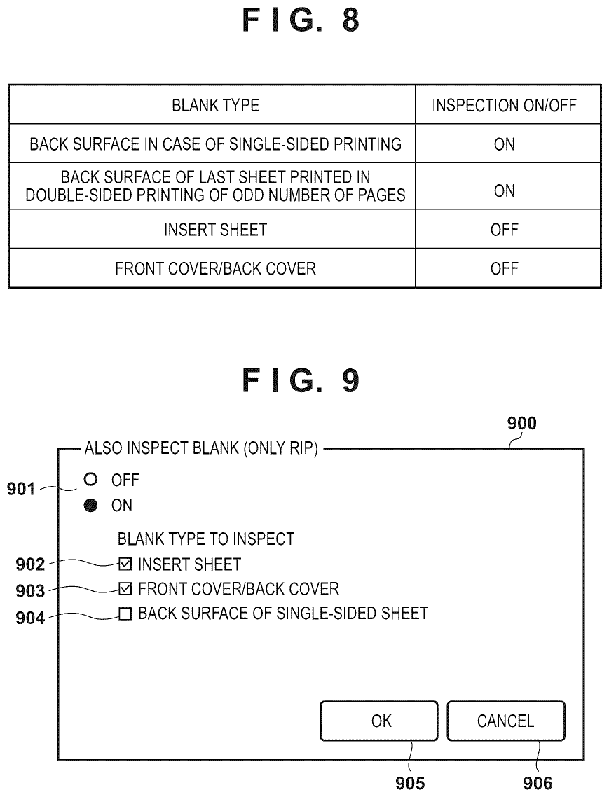

In step S605, the CPU 251 functions as the inspection processing control module 2504 and reads out the information of the blank type for inspection stored in the RAM 252 as illustrated in FIG. 8 and determines whether or not to perform insert sheet inspection.

FIG. 8 is a diagram illustrating an example of a table storing the blank type and the inspection ON/OFF setting according to the first embodiment.

In the example of FIG. 8, inspection is set to ON for a surface that is not printed on when a print job with single-sided printing or printing with an odd number of pages is printed with double-sided printing. Thus, the surface not printed on in a print job with single-sided printing or at the last sheet in a print job for double-sided printing of an odd number of pages corresponds to the target of the inspection. On the other hand, inspection is set to OFF for an insert sheet and front cover/back cover. Thus, inspection is not performed on the insert sheet and the front cover and the back cover. In the first embodiment, a preset table is stored in the inspection apparatus 150 in advance. However, the present invention is not limited thereto. For example, a UI such as that illustrated in FIG. 9 described below in a second embodiment may be provided for receiving a setting from a user. When a setting is received from the UI and a setting is changed, the settings table of FIG. 8 is overwritten.

In this manner, in step S605, when the information of the blank type to be inspected is read out from the RAM 252, the CPU 251 determines whether or not the insert sheet inspection is ON. In a case where ON is determined, the processing proceeds to step S606. In a case where OFF is determined, the processing proceeds to step S607. In step S606, the CPU 251 functions as the inspection processing control module 2504 and determines whether or not the sheet to be inspected is an insert sheet from the image allocation information stored in the RAM 252 and received in step S602. Here, if it is determined to be the insert sheet, the processing proceeds to step S618. If it is determined to not be the insert sheet, the processing proceeds to step S607.

In step S607, the CPU 251 functions as the inspection processing control module 2504 and reads out the information of the blank type for inspection stored in the RAM 252 and determines whether or not the front cover/back cover inspection is ON. In a case where ON is determined, the processing proceeds to step S608. In a case where OFF is determined, the processing proceeds to step S616. In step S608, the CPU 251 functions as the inspection processing control module 2504 and determines whether or not the sheet to be inspected is a front cover or a back cover from the image allocation information received in step S602. Here, in a case where it is determined to be the front cover or the back cover, the processing proceeds to step S609. In a case where it is determined to not be the front cover or the back cover, the processing proceeds to step S616. In step S616, the CPU 251 functions as the inspection processing control module 2504 and reads out the information of the blank type for inspection stored in the RAM 252 and determines whether or not inspection of the surface not printed on a print job for performing single-sided printing or performing double-sided printing of an odd number of pages is ON. In a case where inspection of the surface not printed on is determined to be ON, the processing proceeds to step S609. In a case where it is determined to be OFF, the processing proceeds to step S613.

In step S609, the CPU 251 functions as the inspection processing control module 2504 and determines whether or not it is double-sided printing from the image allocation information stored in the RAM 252 and received in step S602. In a case where it is determined to be double-sided printing, the processing proceeds to step S610. In a case where it is determined to be single-sided printing, the processing proceeds to step S617. In step S617, the CPU 251 functions as the inspection processing control module 2504 and determines whether or not the image ID of the image allocation information stored in the RAM 252 and received in step S602 is 0. In a case where the image ID is determined to be 0, the processing proceeds to step S618. In a case where the image ID is determined to not be 0, the processing proceeds to step S619.

In step S610, the CPU 251 functions as the inspection processing control module 2504 and determines whether or not the image allocation information of the same sheet number has already been received from the image allocation information stored in the RAM 252 and received in step S602. As illustrated in FIG. 7B, the image allocation information is information holding a unique image ID for each page. In the case of double-sided printing, image allocation information of the same sheet number and a different image ID to the printing surface is received. In this example, the image allocation information with an image ID of 2 illustrated in FIG. 7B is received before the image allocation information with an image ID of 1 of FIG. 7A. In the case of double-sided printing, when the image allocation information of both the front and the back is collected, the processing proceeds to the next step. In a case where the image allocation information with the same sheet number has been received, the processing proceeds to step S611. In a case where it has not been received, the processing returns to step S602.

In step S611, the CPU 251 functions as the inspection processing control module 2504 and, from the RAM 252, reads out the image allocation information (FIG. 7B) already received with the same sheet number as the image allocation information (FIG. 7A) stored in the RAM 252 and received in step S602. Here, whether or not both of the image IDs are 0 (whether or not both sides are blank) is determined. In a case where it is determined that both image IDs are 0, that is, both sides are blank, the processing proceeds to step S618. In a case where it is determined that at least one of the image IDs is not 0, that is, one of the two sides is not blank, the processing proceeds to step S612.

In step S618, the CPU 251 functions as the reference image generation module 2503 and generates reference image data of the blanks, allocates the generated reference image data of the blanks to both sides of the corresponding sheet number, and stores this in the RAM 252. In the first embodiment, reference image data of the blank is generated, but no such limitation is intended. A method may be used that uses a pre-stored blank image file, reference data indicating a blank, or specifically pixel data indicating a blank. When the processing of step S618 ends, the processing proceeds to step S613.

In step S612, the CPU 251 functions as the inspection processing control module 2504 and determines which of the image IDs read out from the RAM 252 in step S611 is 0. In a case where one of the image IDs is 0, that is, only one side, the processing proceeds to step S619. In a case where both of the image IDs are not 0, the processing proceeds to step S613.

In step S619, the CPU 251 functions as the reference image generation module 2503 and generates reference image data of the blank, allocates the reference image data of the blank to the side opposite the printing surface with an image ID that is not 0, and stores this in the RAM 252. Then the processing proceeds to step S613. Here, as in step S618, the method of generating the reference image data of the blank is not limited. In step S613, the CPU 251 functions as the inspection processing control module 2504 and reads out the reference image generated in either step S604, step S618, or step S619 and the scanned image received in step S603 and performs inspection on the surface with the reference image. The inspection is as described using the block diagram of the software configuration of the inspection apparatus 150 of FIG. 14.

Next, the processing proceeds to step S614, and the CPU 251 functions as the inspection processing control module 2504 and discards the image allocation information of the sheet numbers for which inspection is completed in step S613. Then, the processing proceeds to step S615, and the CPU 251 functions as the inspection processing control module 2504 and determines whether it is the last sheet from the image allocation information received in step S602. Here, if it is determined that it is not the last sheet, the processing returns to step S602. If it is determined that it is the last sheet, the processing ends.

According to the first embodiment described above, by generating reference image data for a page for which a RIP image is not generated, inspection can be performed on a blank page (surface not printed on) without a RIP image. Also, by identifying the information of the blank type in the image allocation information, instead of uniformly setting ON/OFF for inspecting blanks, automatic switching can be performed to inspect only blanks of a desired type.

### Second Embodiment

In the method according to the first embodiment described above, the information of the blank type to be inspected is stored in the inspection apparatus 150, and automatic switching between inspection ON/OFF is performed. However, in single-sided printing, for example, an inspection of a back surface of a sheet of stamps may wish to be performed due to the back surface being seen by a buyer. However, in the case of posters, since they are attached to a wall, an inspection may be unnecessary due to the back surface not being seen by people. For a user dealing with both cases where an insert sheet is included in the product and cases where an insert sheet is not included, whether inspection is necessary or not may vary even with the same blank type. In a case where the need for inspection of a blank surface changes depending on the product in this manner, the user must be able to switch to a desired settings according to the product. Here, in the second embodiment, an example will be described in which the blank type to be inspected can be selected by the user. The second embodiment will be described below in terms of the differences with the first embodiment described above. Note that configurations that are not described in detail are the same as in the first embodiment.

FIG. 9 is a diagram illustrating an example of a selection screen 900 for the blank type to be inspected displayed on the UI unit 257 of the inspection apparatus 150 according to the second embodiment.

The selection screen 900 for selecting the blank type to be inspected is a screen for receiving the setting of the blank type to be inspected by the inspection apparatus 150 from the user and is displayed on the UI unit 257 by the display control module 2501 executed by the CPU 251 of the inspection apparatus 150. When a setting change is received via the screen 900, the display control module 2501 stores this in the RAM 252.

In a case where the user selects “OFF” for a blank inspection setting area 901, inspection of all of the blanks included in the inspection job is not performed. In a case where “ON” is selected, using checkboxes 902 to 904, the blank type to be inspected is selected. The checkbox 902 is for selecting whether or not to inspect an insert sheet. If the checkbox 902 is checked, a job-to-job partition sheet and a set-to-set partition sheet inserted at the image forming apparatus 100 are also set as targets for inspection. The checkbox 903 is for selecting whether or not to inspect blank surface in a case where a front cover or a back cover includes a blank surface. If the checkbox 903 is checked, blank surfaces of the front cover and the back cover are also set as targets for inspection. The checkbox 904 is for selecting whether or not to inspect a surface not printed on when a print job with single-sided printing is performed or printing with an odd number of pages is performed with double-sided printing. If the checkbox 904 is checked, a blank surface not printed on is also set as a target for inspection. When an OK button 905 is pressed, the display control module 2501 stores the blank inspection setting area 901 and settings received via the checkboxes 902 to 904 in the RAM 252. When a cancel button 906 is pressed, the screen is closed without the present screen settings being stored.

Next, the inspection operations of an inspection job according to the second embodiment will be described with reference to FIGS. 6A and 6B. In the second embodiment, inspection is performed on the basis of information selected at inspection target blank type selection areas. Steps other than steps S605, S607, and S616 are the same as in the first embodiment and thus will not be described.

In step S605, the CPU 251 functions as the inspection processing control module 2504 and reads out the settings received by the display control module 2501 and stored in the RAM 252. At this time, if the blank inspection setting area 901 is “ON” and the insert sheet setting checkbox 902 is checked, the processing proceeds to step S606. In a case where the blank inspection setting area 901 is “OFF” or the checkbox 902 is not checked, the processing proceeds to step S607.

In step S607, the CPU 251 functions as the inspection processing control module 2504 and reads out the settings received by the display control module 2501 and stored in the RAM 252. In a case where the blank inspection setting area 901 is “ON” and the front cover/back cover checkbox 903 is checked, the processing proceeds to step S608. In a case where the blank inspection setting area 901 is “OFF” or the checkbox 903 is not checked, the processing proceeds to step S616.

In step S616, the CPU 251 functions as the inspection processing control module 2504 and reads out the settings received by the display control module 2501 and stored in the RAM 252. In a case where the blank inspection setting area 901 is “ON” and the inspect back side of single-sided sheet checkbox 904 is checked, the processing proceeds to step S609. In a case where the blank inspection setting area 901 is “OFF” or the checkbox 904 is not checked, the processing proceeds to step S613.

According to the second embodiment described above, inspection can be performed for only the blank type desired by the user, and blanks of a type that do not require inspection can be automatically skipped for inspection. Also, blank inspection can be collectively set to ON/OFF.

### Third Embodiment

In the second embodiment described above, inspection is performed for only the blank type desired by the user. However, for inspection of insert sheets, there may be cases in which it is better to not perform inspection even if the user desires blanks to be inspected. In the configuration described using FIG. 2, relating to the large-capacity stacker 120, only a sheet with a defect is discharged to the top tray in inspection. For example, when an inspection of an insert sheet is performed in an inspection job with set-to-set partition sheet set, if a defect is found in the inspection, the partition sheet is discharged to the top tray. The purpose of inserting a set-to-set partition sheet is to divide the copies so make subsequent post-processing such as stapling and binding easier for the user, for example. However, if the partition sheet is discharged to a different discharge destination to sheets without a defect, the partition between copies may be lost.

In the setting method according to the third embodiment described here, the discharge destination is not switched depending on the inspection result in the case of performing an insert sheet inspection. Note that the configuration of the inspection system, the functions and hardware configurations of each apparatus forming the inspection system, and the like according to the third embodiment are similar to those in the embodiments described above and thus will not be described.

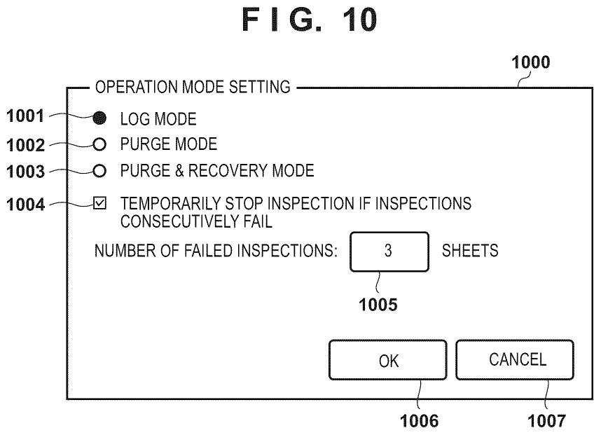

FIG. 10 is a diagram illustrating an example of a settings screen 1000 of an inspection operation mode displayed by the inspection apparatus 150 according to the third embodiment. The inspection operation mode settings screen 1000 is displayed on the UI unit 257 by the display control module 2501 executed by the CPU 251 of the inspection apparatus 150 and receives inspection operation mode settings from the user.

The inspection operation mode settings and inspection operations will be described below.

In a case where “Log mode” is selected for a radio button 1001, the accessory control module 2103 executed by the CPU 211 of the inspection unit 110 does not communicate a discharge destination change instruction based on the inspection result. When a discharge instruction by the accessory control module 2006 executed by the CPU 201 of the image forming apparatus 100 is received, the large-capacity stacker 120 discharges the inspected sheet to the main tray. The accessory control module 2201 executed by the CPU 221 of the large-capacity stacker 120 instructs the discharge unit 225 to discharge to the main tray.

In a case where “Purge mode” is selected for a radio button 1002, the accessory control module 2103 executed by the CPU 211 of the inspection unit 110 communicates that only sheets determined to have a defect in the inspection are to be discharged to the top tray. In a case where a top tray discharge instruction is received from the inspection unit 110, the accessory control module 2201 executed by the CPU 221 of the large-capacity stacker 120 discharges a sheet to the main tray of the discharge unit 225. In a case where “Purge mode” is not selected, when a discharge instruction by the accessory control module 2006 executed by the CPU 201 of the image forming apparatus 100 is received, a sheet is discharged to the main tray of the discharge unit 225.

In a case where “Purge and recovery mode” is selected for a radio button 1003, the accessory control module 2103 executed by the CPU 211 of the inspection unit 110 communicates that sheets determined to have a defect in the inspection and subsequent sheets already feed inside the image forming apparatus 100 are all to be discharged to the top tray of the discharge unit 225. Also, the accessory control module 2103 communicates a temporary stop instruction for printing to the image forming apparatus 100. When the temporary stop instruction for printing is received, the accessory control module 2006 executed by the CPU 201 of the image forming apparatus 100 notifies the print control module 2005 executed by the CPU 201, and the print control module 2005 instructs the printer 209 to temporarily stop printing. When a top tray discharge notification is received from the inspection unit 110, the accessory control module 2201 executed by the CPU 221 of the large-capacity stacker 120 instructs the discharge unit 225 to discharge all of the sheets conveyed from the image forming apparatus 100 to the top tray. Then, when the last sheet has been discharged, the accessory control module 2201 transmits a discharged from apparatus notification to the image forming apparatus 100. When the discharged from apparatus notification is received, the accessory control module 2006 of the image forming apparatus 100 determines that discharge of all of the sheets inside the apparatus is complete and communicates a resume printing instruction to the print control module 2005.

At the time when the inspection processing unit 256 determines that an image of the printed material has a defect, there is a possibility that subsequent sheets have already been subjected to printing processing at the image forming apparatus 100. However, if sheets subjected to printing processing are all not discharged, it is impossible to print the sheet with a defect again and stack the sheets in the correct output order at the discharge destination pre-designated in the print job. Thus, an operation such as the “Purge and recovery mode” is executed.

If a checkbox 1004 is checked, a mode is enabled in which, when there are consecutive failed inspections, inspection is temporarily stopped. At this time, the number of consecutive occurrences to temporarily stop the inspection can be set via a text box 1005. The accessory control module 2103 executed by the CPU 211 of the inspection unit 110 receives the numerical value (number of fails to stop) received via the text box 1005 from the notification module 2505 executed by the CPU 251 of the inspection apparatus 150. Then the number of consecutive occurrences of a defect that has actually occurred and the number of fails to stop are compared, and in a case where the number of consecutive occurrences is greater than the number of fails to stop, the inspection apparatus 150 is instructed to display the inspection defect consecutive occurrences on the UI unit 257. Also, the image forming apparatus 100 is instructed to temporarily stop the printing. At this time, a notification may be transmitted to the image forming apparatus 100 communicating that a paper jam has occurred in the inspection unit 110, and the printing operation in the image forming apparatus 100 may be stopped, however no such limitation is intended.

When the temporary stop instruction for printing is received, the accessory control module 2006 executed by the CPU 201 of the image forming apparatus 100 notifies the print control module 2005 executed by the CPU 201, and the print control module 2005 instructs the printer 209 to temporarily stop printing. The accessory control module 2201 executed by the CPU 221 of the large-capacity stacker 120 discharges all of the sheets to the discharge destination designated in the notification from the inspection unit 110 or the image forming apparatus 100. When the last sheet has been discharged, the accessory control module 2201 transmits a discharged from apparatus notification to the image forming apparatus 100.

When an instruction to resume printing is received at the display control module 2501 of the inspection apparatus 150 from the user, the notification module 2505 executed by the CPU 251 of the inspection apparatus 150 transmits a resume notification to the inspection unit 110. Accordingly, the accessory control module 2103 of the inspection unit 110 transmits a resume printing instruction to the image forming apparatus 100. When a discharged from apparatus notification and a resume printing instruction are received by the accessory control module 2006 executed by the CPU 201 of the image forming apparatus 100, the print control module 2005 instructs the printer 209 to resume printing. Note that in a case where the checkbox 1004 is not checked, the text box 1005 is greyed out and not input can be received.

Note that for the operation mode, only one of the “Log mode”, “Purge mode”, and the “Purge and recovery mode” can be selected. Also, regardless of the operation mode, “Stop printing when consecutive inspection fails occur mode” can be switched ON and OFF.

When an OK button 1006 is pressed, the settings received on the screen 1000 are stored in the RAM 252. When a cancel button 1007 is pressed, the screen is closed without storing the settings of the present screen. The third embodiment will be described below in terms of the differences with the first embodiment described above. Note that configurations that are not described in detail are the same as in the first embodiment.

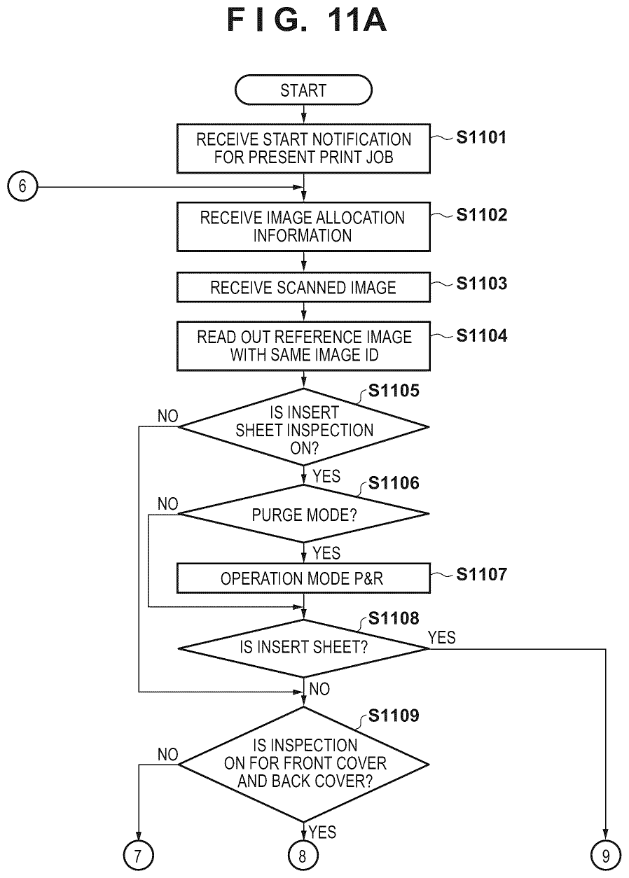

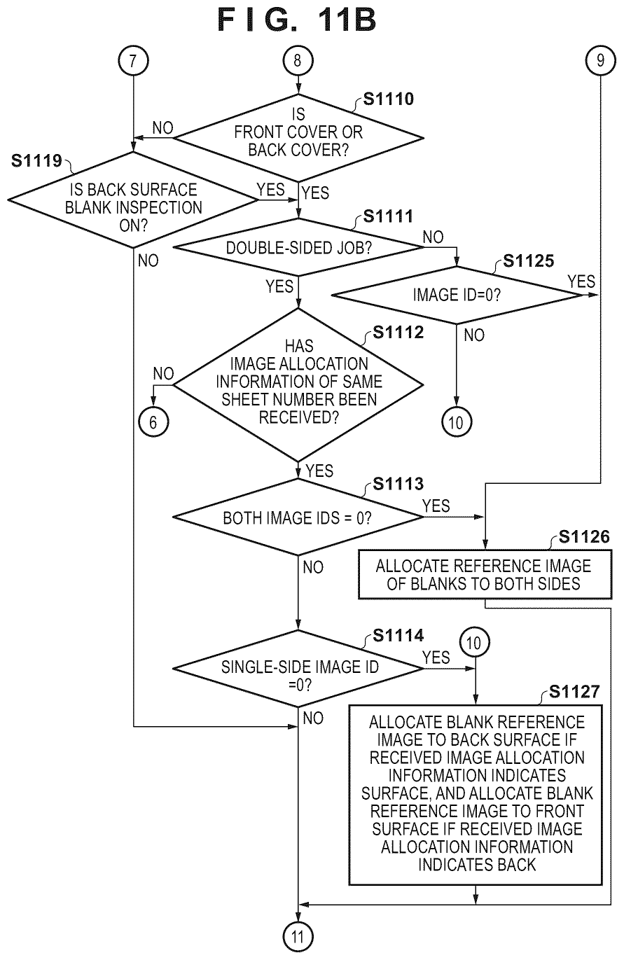

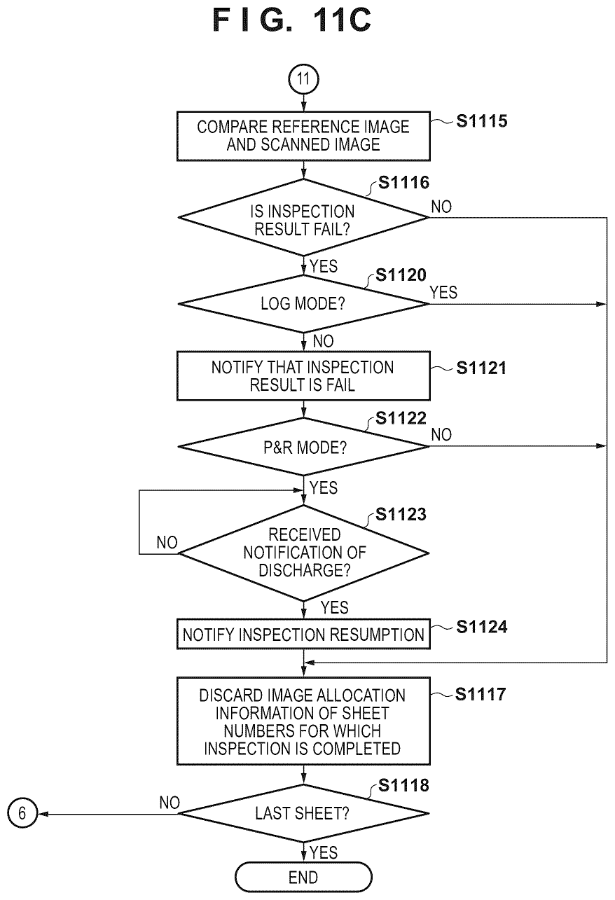

FIGS. 11A-11C are flowcharts for describing the flow of inspection in the inspection system according to the third embodiment. Note that in FIG. 11A, steps S1101 to S1105 are similar to steps S601 to S605 of FIG. 6A in the first embodiment and thus will not be described.

In step S1106, the CPU 251 of the inspection apparatus 150 functions as the inspection processing control module 2504 and reads out the operation mode received by the display control module 2501 and stored in the RAM 252. The CPU 251 determines the operation mode read out, and if it is determined that the operation mode is a mode other than “Purge mode”, the processing proceeds to step S1108. If it is determined that the operation mode is “Purge mode”, the processing proceeds to step S1107 where the CPU 251 functions as the inspection processing control module 2504 and changes the operation mode to “Purge and recovery mode” and stores this setting in the RAM 252.

In this manner, the operation mode is set to “Purge and recovery mode” only for inspection jobs for inspecting insert sheets. This can avoid an insert sheet inserted to make obvious the partition between copies for the user being purged. Accordingly, even in a case where a defect is detected in an insert sheet inspection, since recovery printing is performed from the insert sheet, an effect of preventing the partition between copies from being lost due to the insert sheet inserted by the user being purged can be achieved.

Note that in the example according to the third embodiment described above, the setting is automatically changed to “Purge and recovery mode” for inspection jobs in which an insert sheet is inspected. However, another method of preventing an insert sheet being discharged to another tray when “Log mode” is set may also be used, and the format of these methods is not limited.

The subsequent steps S1108 to S1114, step S1119, and steps S1125 to S1127 are similar to steps S606 to S612, step S617 to step S619 of FIGS. 6A and 6B of the first embodiment and thus will not be described.

In step S1115, the CPU 251 functions as the inspection processing control module 2504 and reads out the reference image generated in either step S1104, step S1126, or step S1127 and the scanned image received in step S1103 and performs inspection on the surface with the reference image. The inspection is as described using FIG. 14.

In step S1116, the CPU 251 functions as the inspection processing control module 2504 and determines the processing according to the inspection result. In a case where the inspection result of the sheet inspected in step S1115 shows a defect (inspection result of fail), the processing proceeds to step S1120 (FIG. 11C). In a case where the inspection result shows no defect (inspection result of OK), the processing proceeds to step S1117.

In step S1120, the CPU 251 functions as the inspection processing control module 2504 and reads out the operation mode from the RAM 252. If the operation mode is determined to be “Log mode”, the processing proceeds to step S1117. If the operation is determined to be a mode other than “Log mode”, the processing proceeds to step S1121. In step S1121, the CPU 251 functions as the notification module 2505 and notifies the inspection unit 110 of the inspection result fail. When the notification of the inspection result fail is received, the CPU 211 of the inspection unit 110 functions as the accessory control module 2103 and sends an instruction to discharge a sheet with a defect to the top tray to the large-capacity stacker 120. When an instruction to discharge to the top tray is received by the large-capacity stacker 120, the CPU 221 functions as the accessory control module 2201 and controls to discharge the sheet with the defect to the top tray.

Next, in step S1122, the CPU 251 functions as the inspection processing control module 2504 and reads out and determines the operation mode from the RAM 252. If the operation mode is determined to be “Purge and recovery mode”, the processing proceeds to step S1123. If the operation mode is not “Purge and recovery mode”, that is, it is determined to be “Purge mode”, the processing proceeds to step S1117.

In step S1123, the CPU 251 functions as the notification module 2505 and transmits the inspection result fail to the inspection unit 110. When the inspection unit 110 receives an instruction to stop printing/inspection, the CPU 211 functions as the accessory control module 2103 and transmits a stop printing instruction to the image forming apparatus 100. When the image forming apparatus 100 receives the stop printing instruction, the CPU 201 functions as the image processing control module 2003 and instructs the printer 209 to stop printing. Also, the image read control module 2101 of the inspection unit 110 instructs the image reading unit 216 to stop reading the sheet. The accessory control module 2201 of the large-capacity stacker 120 controls the discharge unit 225 so that sheets are discharged to the top tray until they stop being conveyed from the image forming apparatus 100 and then, when discharge ends, transmits a discharged from apparatus notification to the image forming apparatus 100 and the inspection unit 110. Then, the processing proceeds to step S1124. In step S1124, the CPU 211 of the inspection unit 110 functions as the data control module 2102 and notifies the inspection apparatus 150 of printing and inspection resumption. At this time, the image processing control module 2003 of the image forming apparatus 100 instructs the printer 209 to resume printing. The image read control module 2101 of the inspection unit 110 instructs the image reading unit 216 to read the sheet. Thereafter, the processing proceeds to step S1117. Step S1117 and step S1118 are similar to step S614 and step S615 of FIG. 6B in the first embodiment and thus will not be described.

According the third embodiment described above, even in a case where the user wishes to inspect blanks, the user can designate a blank type (for example, insert sheet) to not execute post-processing on for sheets that failed inspection. This can prevent the situation of an insert sheet, that is, a blank, from being discharged to another discharge destination due to the insert sheet failing an inspection and thus making the insertion of the insert sheet meaningless.

Also, according to the third embodiment, an effect can be achieved in which inspection can be set to be temporarily stopped when consecutive inspection fails occurs and the number of consecutive fails needed can be set to any number.

### Fourth Embodiment

In the example according to the third embodiment described above, when inspecting insert sheets, by setting the operation mode to a mode other than “Purge mode”, the insert sheet inserted to make obvious the partition between copies by the user being discharged to a different tray to the product is prevented. However, when operating in “Purge and recovery mode”, printing and inspection are repeated until an OK is obtained as the inspection result for a sheet that had fail as the inspection result. At this time, when the insert sheet inspection result is repeatedly fail, printing and inspection of the insert sheet is repeated, meaning that printing and inspection of the product problematically stops progressing.

Here, in an example according to the fourth embodiment described herein, printing and inspection are stopped in a case where the insert sheet inspection is operating in “Purge and recovery mode” and the inspection result is determined as fail for a predetermined number of times. The fourth embodiment will be described below in terms of the differences with the third embodiment described above. Note that configurations that are not described in detail are the same as in the third embodiment.

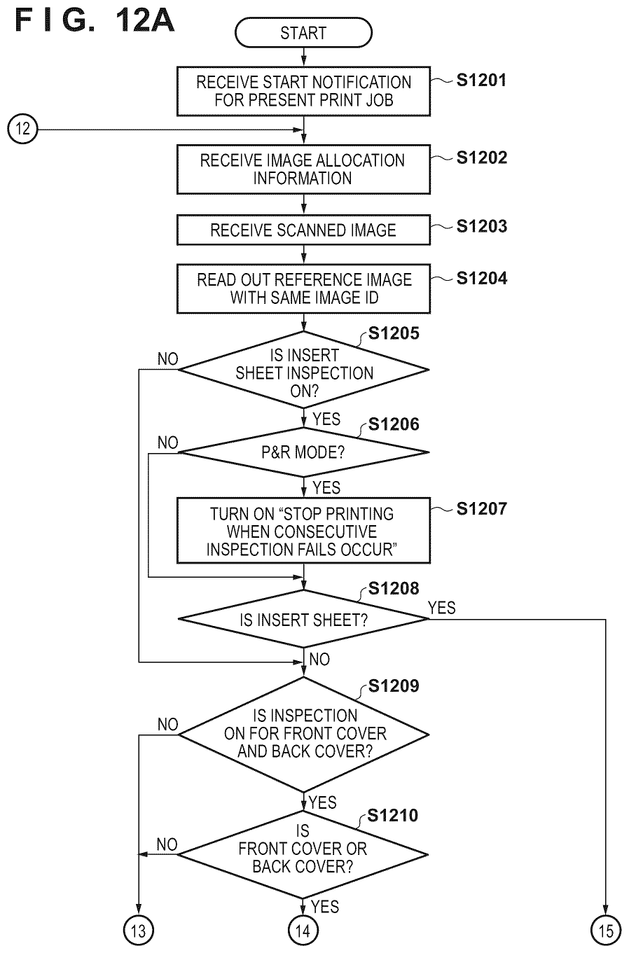

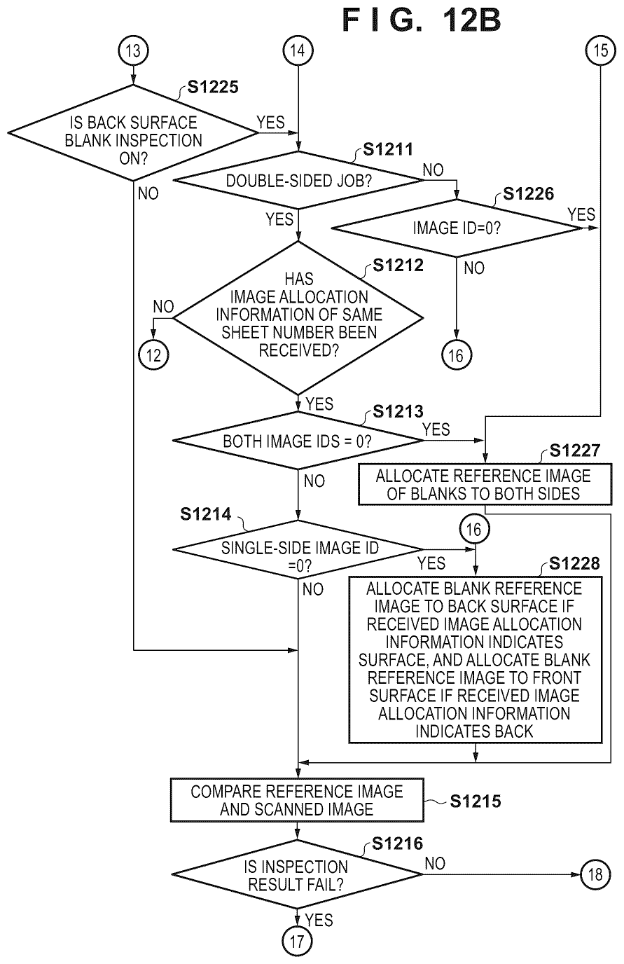

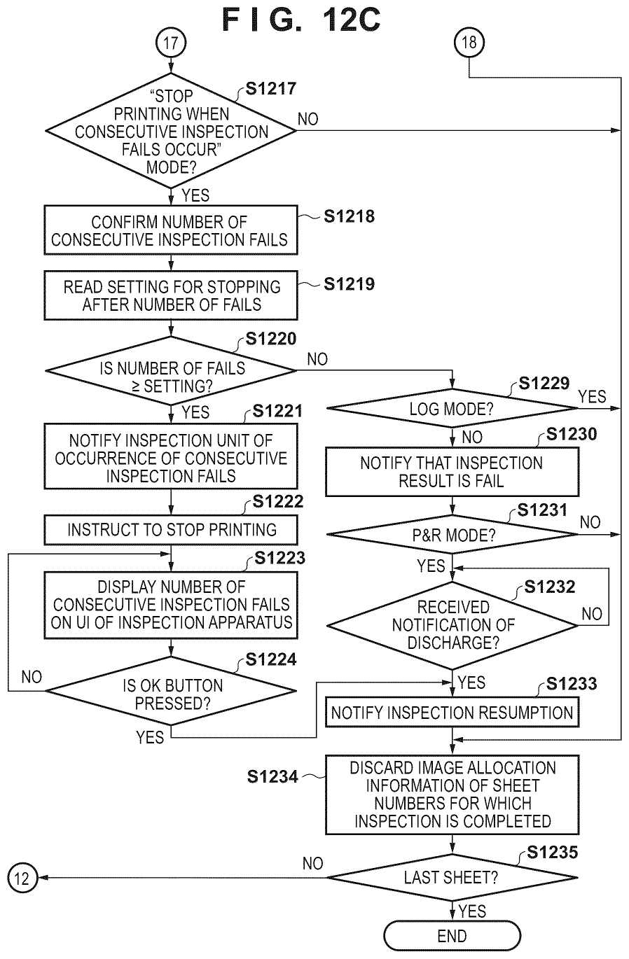

FIGS. 12A-12C are flowcharts for describing the flow of inspection in the inspection system according to the fourth embodiment. Note that in FIG. 12A, steps S1201 to S1205 are similar to steps S601 to S605 of FIG. 6A in the first embodiment and thus will not be described.

In step S1206, the CPU 251 of the inspection apparatus 150 functions as the inspection processing control module 2504 and reads out the operation mode received by the display control module 2501 and stored in the RAM 252. The CPU 251 determines the operation mode, and if it is determined that the operation mode is a mode other than “Purge and recovery mode”, the processing proceeds to step S1208. On the other hand, in a case where the operation mode is determined to be “Purge and recovery mode”, the processing proceeds to step S1207, and the CPU 251 changes the “Stop printing when consecutive inspection fails occur mode” to ON and stores this setting in the RAM 252. Steps S1208 to S1216 are similar to steps S1108 to S1116 of the third embodiment and explanations of the steps will not be described.

In step S1217 of FIG. 12C, the CPU 251 functions as the inspection processing control module 2504 and reads out the operation mode from the RAM 252. Here, if the mode is determined to not be the “Stop printing when consecutive inspection fails occur mode”, the processing proceeds to step S1234. In a case where the mode is determined to be the “Stop printing when consecutive inspection fails occur mode”, the processing proceeds to step S1218. In step S1218, the CPU 251 functions as the inspection processing control module 2504 and stores the number of consecutive inspection result fails in an inspection job being executed (number of consecutive inspection fails) in the RAM 252. Then, the processing proceeds to step S1219, and the CPU 251 functions as the inspection processing control module 2504 and reads out the number of fails to stop stored in the RAM 252 received by the display control module 2501. Then the processing proceeds to step $1220.

In step S1220, the CPU 251 functions as the inspection processing control module 2504 and compares the number of consecutive inspection fails and the numerical value input in the text box 1005. If it is determined that the number of consecutive inspection fails is equal to or greater than the number of fails to stop, the processing proceeds to step S1221. However, in a case where the number of consecutive inspection fails is less than the number of fails to stop, the processing proceeds to step S1229. Steps S1229 to S1233 are similar to steps S1120 to S1124 in FIG. 11C and explanations of the steps will not be described.

In step S1221, the CPU 251 functions as the notification module 2505 and notifies the inspection unit 110 that consecutive inspection fails have occurred the predetermined number of times. Then, the processing proceeds to step S1222, and the CPU 251 functions as the notification module 2505 and transmits a stop printing instruction to the inspection unit 110. When the inspection unit 110 receives the stop printing instruction, the CPU 211 functions as the accessory control module 2103 and transmits a stop printing instruction to the image forming apparatus 100. When the image forming apparatus 100 receives the stop printing instruction, the CPU 201 functions as the image processing control module 2003 and instructs the printer 209 to stop printing. Also, the CPU 211 of the inspection unit 110 functions as the image read control module 2101 and instructs the image reading unit 216 to stop reading the sheet. Also, the accessory control module 2201 of the large-capacity stacker 120 controls the discharge unit 225 so that sheets are discharged to the top tray until they stop being conveyed from the image forming apparatus 100 and then, when discharge of the sheets ends, transmits a discharged from apparatus notification to the image forming apparatus 100 and the inspection unit 110.

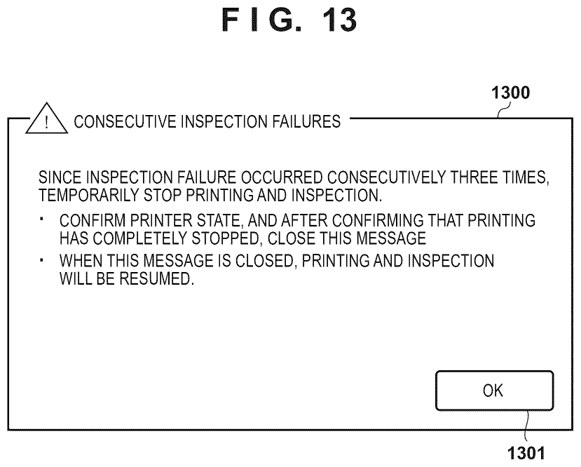

The processing proceeds to step S1223, and the CPU 251 functions as the display control module 2501 and displays information indicating that consecutive inspection fails have occurred on the UI unit 257 as illustrated in FIG. 13.

FIG. 13 is a diagram illustrating an example of a consecutive fails dialog 1300 displayed on the UI unit 257 of the inspection apparatus 150 according to the fourth embodiment.

The dialog 1300 is an example of a screen for presenting to the user that a number of consecutive inspection fails have occurred equaling the number set by the user on the inspection operation mode settings screen 1000 and is displayed on the UI unit 257 of the inspection apparatus 150. Here, the number to stop printing and inspection in the case of consecutive inspection fails is three times. On the consecutive fails dialog 1300, a message prompting the user to check that printing operations have stopped in the image forming apparatus 100 is displayed. An OK button 1301 is for the user to press when the user has confirmed that printing operations in the image forming apparatus 100 has stopped.

In step S1224, the CPU 251 functions as the display control module 2501 and determines whether a press of the OK button 1301 by the user has been received. Until the OK button 1301 is pressed, in step S1223, the display of the consecutive fails dialog 1300 is continued. When the OK button 1301 is pressed, the processing proceeds from step S1224 to step S1233. In step S1233, the CPU 211 of the inspection unit 110 functions as the data control module 2102 and notifies the inspection apparatus 150 of printing and inspection resumption. Steps S1233 to S1235 are similar to steps S1124 to S1126 of the third embodiment and explanations of the steps will not be described.

According to the fourth embodiment described above, in a case where an inspection job for inspecting insert sheets is operated in the “Purge and recovery mode”, inspection is performed with the “Stop printing when consecutive inspection fails occur mode” automatically set to ON. This can prevent printing of the product (document) not progressing due to the insert sheet being repeated printed and inspections failing.

Note that in the examples according to the embodiment described above, inspection is performed with the inspection apparatus 150 and the inspection unit 110. However, the present invention is not limited thereto, and an inspection apparatus provided with the functions of the inspection apparatus 150 and the inspection unit 110 may be used. In this case, the inspection apparatus receives the printed material printed by the image forming apparatus 100, obtains the scanned image obtained by reading the printed material, and performs an inspection by comparing the scanned image and the reference image.

### Modified Example of Embodiments

In the embodiments described above, blank inspection by the inspection apparatus is set to on or off on the basis of allocation information such as that illustrated in FIGS. 7A and 7B and blank type and inspection ON/OFF settings such as those illustrated in FIG. 8.

Alternatively, in a modified example of the embodiments, the information processing apparatus 140 or the client PC 130 may include a table for determining the blank type and the inspection ON/OFF settings such as those illustrated in FIG. 8, and blank inspection may be set to on or off from a job ticket. In this case, for example, the client PC 130 may display a screen such as that illustrated in FIG. 9 on the UI unit 235 and update the table described above on the basis of the content set via the screen. This can allow the user of a PC to easily set whether or not to perform the desired blank inspection for the print job to be executed.

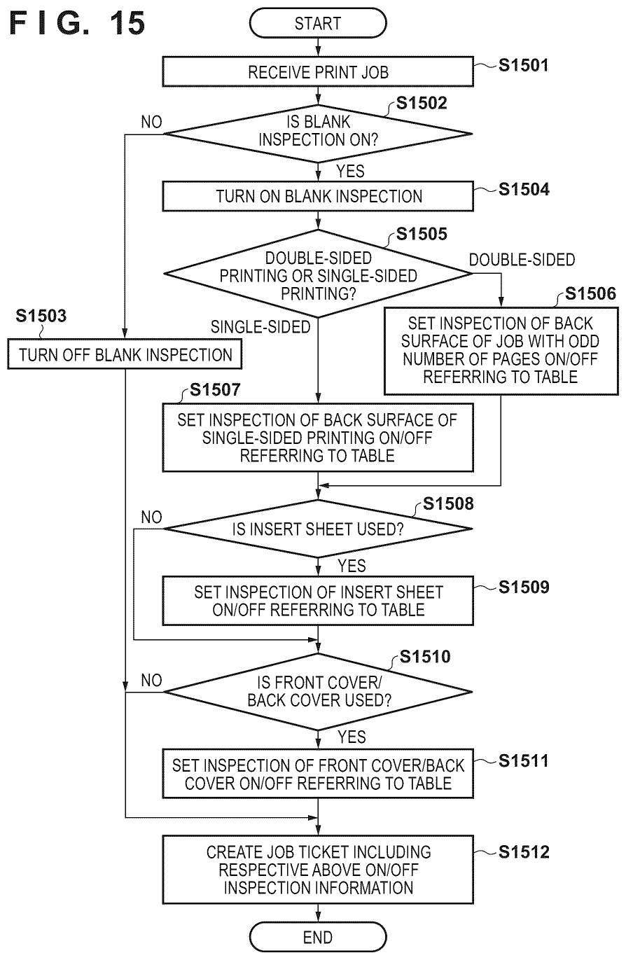

FIG. 15 is a flowchart for describing the processing of generating a job ticket in the client PC 130 according to a modified example of the embodiments of the present invention. The processing illustrated by the flowchart is implemented by the CPU 231 executing a program deployed on the RAM 232.

First, this processing is premised on the client PC 130 displaying a UI screen such as that illustrated in FIG. 9 described above on the UI unit 235 and receiving, via this screen, settings including whether or not to inspect an input blank, the blank inspection type, and an ON/OFF setting (setting of whether or not to perform inspection). Then, the received settings are stored in a table format such as that illustrated in FIG. 8, for example. Note that the table is stored in the RAM 232 of the client PC 130 or a non-volatile storage unit (not illustrated), for example.

First, in step S1501, when a print job is received, the processing proceeds to step S1502, and the CPU 231 determines whether or not, in the job properties of the print job, blank inspection is set to ON, that is, whether or not to perform blank inspection. When blank inspection is to be performed, the processing proceeds to step S1504. Then, blank inspection to set to ON, and the processing proceeds to step S1505. However, when blank inspection is not ON, the processing proceeds to step S1503. Blank inspection is set to OFF in step S1503, and the processing proceeds to step S1512. Note that when blank inspection is OFF, the settings for inspections corresponding to all of the plurality of blank inspection types described above are set to OFF.

In step S1505, the CPU 231 determines whether or not double-sided printing is designated for the print job. If it is determined that double-sided printing is set, the processing proceeds to step S1506, and the CPU 231 references a table such as that illustrated in FIG. 8, for example, and sets the setting to inspect the back surface of the print job with an odd number of pages according to whether the inspection setting for the back surface of print jobs with an odd number of pages when double-sided printing is set to ON or OFF. Then, the processing proceeds to step S1508. In step S1505, if the CPU 231 determines that single-sided printing is set, the processing proceeds to step S1507, and the CPU 231 references the table described above and sets the setting to inspect the back surface when single-sided printing according to whether the inspection setting for the back surface when single-sided printing is set to ON or OFF. Then, the processing proceeds to step S1508.

In step S1508, the CPU 231 determines whether or not an insert sheet is used in the print job. If it is determined that an insert sheet is used, the processing proceeds to step S1509. If it is determined that an insert sheet is not used, the processing proceeds to step S1510. In step S1509, the CPU 231 references the table of FIG. 8 and sets the insert sheet inspection setting according to whether the insert sheet inspection setting is set to ON or OFF. Then, the processing proceeds to step S1510.

In step S1510, the CPU 231 determines whether or not a front cover/back cover is used in the print job. If it is determined that a front cover/back cover is used, the processing proceeds to step S1511. If it is determined that a front cover/back cover is not used, the processing proceeds to step S1512. In step S1511, the CPU 231 references the table described above and sets the front cover/back cover inspection setting according to whether the front cover/back cover inspection setting is set to ON or OFF. Then, the processing proceeds to step S1512. In step S1512, the CPU 231 includes the ON/OFF setting for inspections corresponding to the blank types set in the processing described above in a job ticket of the print job and generates the job ticket. In this manner, the print job is transmitted together with the job ticket to the image forming apparatus 100. Note that the processing of FIG. 15 may be executed by the information processing apparatus 140.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-076089, filed May 8, 2024, which is hereby incorporated by reference herein in its entirety.

What is claimed is:

1. An inspection system comprising an inspection apparatus and a printing apparatus communicatively connected to one another,
the printing apparatus including
one or more first controllers including one or more first processors and one or more first memories, the one or more first controllers configured to:
print on a print medium on a basis of print image data and generate a printed material, and
transmit and receive the print image data and print settings information of the print image data, and
the inspection apparatus including
one or more second controllers including one or more second processors and one or more second memories, the one of more second controllers configured to:
receive the print image data and the print settings information from the printing apparatus,
generate a reference image using the print image data and the print settings information received,
register the reference image generated,
store settings information for inspecting the printed material, and
perform an inspection of the printed material on a basis of the settings information, a scanned image obtained by scanning an image printed on the printed material, and a reference image corresponding to the scanned image,
wherein in the inspection, if the settings information includes a predetermined setting, the one or more second controllers inspect a scanned image corresponding to a blank using a predetermined reference image.

2. The inspection system according to claim 1, wherein
the settings information, in a case of settings for inspecting blanks, includes at least one setting of whether or not to perform inspection in a case where a sheet to be inspected is an insert sheet, whether or not to perform inspection in a case where the printed material is a front cover or a back cover, and whether or not to perform inspection of a back surface of the printed material in a case where the back surface is a blank; and
in the predetermined setting, at least one of the whether or not to perform inspections is set to be need.

3. The inspection system according to claim 1, wherein
the blank includes an insert sheet, a front cover or a back cover, a surface where an image of a printed material is not printed in single-sided printing, and, in a case of printed materials are printed by print image data of an odd number of pages in double-sided printing, a surface of a printed material where an image is not printed due to there being no corresponding print image data.

4. The inspection system according to claim 1, wherein
the print settings information includes at least one of information indicating whether or not to print the print image data on a front cover or a back cover, whether or not the print settings information is print data for a front cover or back cover of the print medium, and whether single-sided printing or double-sided printing is performed.

5. The inspection system according to claim 1, wherein
the one or more controllers are further configured to set the settings information.

6. The inspection system according to claim 1, further comprising:
an information processing apparatus configured to transmit the print image data to the printing apparatus,
wherein the one or more second controllers receive the settings information from the information processing apparatus.

7. The inspection system according to claim 1, wherein
the predetermined reference image is a reference image corresponding to a blank page.

8. The inspection system according to claim 7, wherein
the reference image corresponding to a blank page includes pixel data indicating white.

9. The inspection system according to claim 1, wherein
the one or more second controllers, in registration of the reference image, provide and register the reference image with a reference image parameter, and
the reference image parameter includes an ID for a job to be inspected, and image ID, and information indicating blank or not.

10. The inspection system according to claim 1, wherein
the one or more second controllers are further configured to perform control to
receive an operation setting for when an inspection is performed,
switch a discharge destination of the printed material according to an inspection result of inspection of the printed material, and
in a case where the operation setting is a predetermined operation setting, change the operation setting and not switch the discharge destination of the printed material according to the inspection result.

11. The inspection system according to claim 10, wherein
the operation setting includes a consecutive fail number of consecutive fails in inspection, and
in a case where a number of consecutive fails reaches the consecutive fail number in the inspection, the one or more second controllers instruct the printing apparatus to stop printing.

12. The inspection system according to claim 11, wherein
in a case where the operation setting includes insert sheet inspection and the discharge destination of the printed material is set to not switch according the inspection result of the inspection, the one or more second controllers instructs the printing apparatus to stop printing in a case where the number of consecutive fails reaches the consecutive fail number.

13. An inspection apparatus configured to receive and inspect a printed material printed by a printing apparatus, comprising:
one or more controllers including one or more processors and one or more memories, the one or more controllers being configured to:
generate a reference image using print image data of the printed material and print settings information,
register the reference image generated,
store settings information for inspecting the printed material, and
perform an inspection of the printed material on a basis of the settings information, a scanned image obtained by scanning an image printed on the printed material, and a reference image corresponding to the scanned image,
wherein, in the inspection, if the settings information includes a predetermined setting, the one or more controllers inspect a scanned image corresponding to a blank using a predetermined reference image.

14. The inspection apparatus according to claim 13, wherein
the settings information, in a case of settings for inspecting blanks, includes at least one setting of whether or not to perform inspection in a case where a sheet to be inspected is an insert sheet, whether or not to perform inspection in a case where the printed material is a front cover or a back cover, and whether or not to perform inspection of a back surface of the printed material in a case where the back surface is a blank; and
in the predetermined setting, at least one of the whether or not to perform inspection is set to be need.

15. The inspection apparatus according to claim 13, wherein
the blank includes an insert sheet, a front cover or a back cover, a surface where an image of a printed material is not printed in single-sided printing, and, in a case of printed materials are printed by print image data of an odd number of pages in double-sided printing, a surface of a printed material where an image is not printed due to there being no corresponding print image data.

16. The inspection apparatus according to claim 13, wherein
the print settings information includes at least one of information indicating whether or not to print the print image data on a front cover or a back cover, whether or not the print settings information is print data for a front cover or back cover of the print medium, and whether single-sided printing or double-sided printing is performed.

17. The inspection apparatus according to claim 13, wherein
the one or more controllers are further configured to set the settings information.

18. The inspection apparatus according to claim 13, wherein
the predetermined reference image is a reference image corresponding to a blank page.

19. The inspection apparatus according to claim 13, wherein
the one or more controllers, in registration of the reference image, provide and register the reference image with a reference image parameter, and
the reference image parameter includes an ID for a job to be inspected, and image ID, and information indicating blank or not.

20. The inspection apparatus according to claim 13, wherein
the one or more controllers are further configured to perform control to
receive an operation setting for when an inspection is performed,
switch a discharge destination of the printed material according to an inspection result of the inspection, and
in a case where the operation setting is a predetermined operation setting, change the operation setting and not switch the discharge destination of the printed material according to the inspection result.

21. A method of controlling an inspection apparatus configured to receive and inspect a printed material printed by a printing apparatus, comprising:
generating a reference image using the print image data of the printed material and the print settings information;
registering the reference image generated;
storing settings information for inspecting the printed material; and
performing an inspection of the printed material on a basis of the settings information, a scanned image obtained by scanning an image printed on the printed material, and a reference image corresponding to the scanned image,
wherein in the inspection, if the settings information includes a predetermined setting, inspecting a scanned image corresponding to a blank not registered in the registering using a predetermined reference image.
